(19) United States
(12) Patent Application Publication
(10) Pub. No.: US 2014/0310071 A1
(43) Pub. Date: Oct. 16, 2014

(54) PHYSICALLY-BASED FINANCIAL ANALYSIS AND/OR FORECASTING METHODS, APPARATUS, AND SYSTEMS

(71) Applicant: BETAZI, LLC, Austin, TX (US)

(72) Inventors: Janette Conradson, Truckee, CA (US); Nimar S. Arora, Union City, CA (US); Heidi A. Kuzma, Truckee, CA (US); Christian Pierce, Truckee, CA (US); Wesly Ketcham, Chicago, IL (US)

(73) Assignee: BETAZI, LLC, Austin, TX (US)

(21) Appl. No.: 14/209,018

(22) Filed: Mar. 13, 2014

Related U.S. Application Data
(63) Continuation-in-part of application No. 14/170,185, filed on Jan. 31, 2014.
(60) Provisional application No. 61/780,674, filed on Mar. 13, 2013.

(51) Int. Cl. G06Q 10/06; G06Q 10/04

(52) U.S. Cl. CPC G06Q 10/06375; G06Q 10/04
USPC 705/7.37

(57) ABSTRACT

Methods and apparatus for modeling well production. Such methods comprise modeling a production of a well (perhaps an open universe, generative model). Methods also comprise determining probability distributions for physical parameters associated with the well by training the model with historic well production data (perhaps using sparse sampling). Such methods also comprise determining a posterior distribution for the model by sampling probability distributions for the parameters. Some methods further comprise determining a posterior distribution for the well's production using the model's posterior distribution. Non-Gaussian (Laplacian) noise can be added to the model. Methods can comprise financially modeling the well. Some methods comprise using MCMC sampling to converge the parameter posterior distribution for the well's production. An EUR for the well can be determined along with an uncertainty associated with the posterior distribution for the production. If desired, some methods comprise modeling multi-phase flow in the well.

### CROSS REFERENCE TO RELATED APPLICATIONS

This application is a non provisional application of, and claims priority to, U.S. provisional patent application No. 61/780,674 titled FINANCIAL ANALYSIS TOOLS DERIVED FROM THE OUTPUT OF A PHYSICALLY-BASED PROBABILISTIC PRODUCTION ANALYSIS SYSTEM (PPAS) FOR OIL, GAS, AND WATER WELLS, filed on Mar. 13, 2013, by Nimar, S. Arora et al., the entirety of which is incorporated herein as if set forth in full. This application is also a continuation in part of U.S. patent application Ser. No. 14/170,185 titled PHYSICALLY-BASED PROBABILISTIC PRODUCTION ANALYSIS SYSTEM (PPAS) FOR OIL, GAS, AND WATER WELLS, filed on Jan. 31, 2014, by Nimar, S. Arora et al., which is a non provisional application of, and claims priority to, U.S. provisional patent application No. 61/759,118 titled PHYSICALLY-BASED PROBABILISTIC PRODUCTION ANALYSIS SYSTEM (PPAS) FOR OIL, GAS, AND WATER WELLS, filed on Jan. 31, 2013, by Nimar, S. Arora et al., the entirety of both which are incorporated herein as if set forth in full.

### BACKGROUND

Estimates of future production and Estimated Ultimate Recovery (EUR) from oil, gas, and water wells are often inaccurate and can be heavily biased by the practice of fitting production curves by hand using smooth mathematical models. Furthermore, it is difficult, if not impossible, to accurately model, analyze and predict the effects of multi-phase (oil, gas and water) production from the same well; re-pressurization of a well after shut-ins; the effect of well stimulations; hydro fracturing; choke adjustments and changes of pressure; transient flow regimes; time-dependent permeability; and/or other factors. Moreover, it may or may not be possible to physically monitor such factors during production to even gain data pertinent thereto.

Furthermore, because production data tends to be noisy, many different models (or mathematical curves) with the same or differing form can be fit to the same data. The noise arises from a number of sources including those mentioned above as well as certain operational considerations. For instance, pumps and other equipment sometimes fail leading to potentially large production swings. Furthermore, many field owner/operators and/or other users practice production “allocation.” In other words, many wells will feed one common storage or accumulation tank with the combined and measured outflow (that is “production”) being allocated between those wells. Obviously, these allocations can be inaccurate leading to noise in the production measurements. Further still, the actual production from any given well can vary with time leading to noise in that even once accurate allocations become inaccurate over some time frame.

Of course, well tests in which the production from one or more wells is measured and used to calibrate (or adjust) the allocation can potentially alleviate some of these concerns. Some states mandate that these well tests are preformed on a regular basis, but even then allocations are subject to inaccuracy. For instance, some operators who perform the test might round results up, others might round down, and some operators might not care enough to obtain and/or report accurate results at all.

Furthermore, often during the life cycle of a well, the production regime of the well changes. For example, the well might pass into a new so-called flow regime where fluids are being driven toward the well because of a different mechanism. An example of natural mechanism change would be that the flow regime changes from desorbtion along artificially induced fracture boundaries to that of the native permeability of a formation. An example of man-made flow changes would be that a new pump or form of artificial lift was introduced into the well.

All of these forms of noise accumulate and can render so-called production “measurements” inaccurate or misleading. When field owners use such noisy historic figures to forecast future production, that noise can lead to highly varying projections. Aggravating the situation, most algorithms for production analysis return only one forecast which means that the effects of the cumulative noise remain unknown even if they are appreciated at some minimal or subconscious level. In other words, owner/operators sometimes suspect that their production forecasts are suspect. Yet, heretofore, they have had no better way to forecast future production or analyze past production. Those involved in financial activities derived from, dependent from, and/or based on such uncertain physical production estimates, in addition, have the vicissitudes of the market place with which to contend.

### SUMMARY

The following presents a simplified summary in order to provide an understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. The current disclosure provides systems, apparatus, methods, etc. for performing physically-based well-financial analyses and/or forecasting and, more specifically, for performing physically-based well-financial analyses and forecasting using Bayesian statistics, sparse sampling, and Laplacian, Gaussian, and/or other forms of noise to analyze and forecast physically-based financial performance of various petrochemical wells.

In accordance with embodiments, the current disclosure provides methods which allow users to develop repeatable predictions of financial risk associated with petrochemical production (and/or production of other materials) and to optimize physically-based financial instruments and/or portfolios responsive thereto. The physically-based risk models underlying these activities produce probabilistic predictions of the financial performance of the wells, fields, plays, etc. underlying the model. Moreover, these physically-based financial models account for engineering risk, production risk, financial risk, price risk, transport risk, and/or other forms of risk. More specifically, these models account for (what are typically) the two biggest risk areas: production risk and price risk. As a result, users can choose from a range of portfolios including narrow risk portfolios with higher prices but more assured returns and broader risk portfolios with lower prices but less assured returns.

Outputs of such models can include or be based on probabilistic financial estimates such as net present value (NPV), internal rates of return (IRR), anticipated ends of life, etc. These probabilistic, physically-based, financial predictions can be output in the form of a probabilistic set of curves, histograms, and/or other graphical charts. It is noted here that models of embodiments are physically based in that they are based on comprehensible equations reflecting physical conditions in the wells, fields, plays, etc. such as the physical laws known as Boyle's and Darcy's laws.

Instead of using a fixed (or deterministic) function to describe well decline (or production), methods provided herein use a probabilistic knowledge representation. That knowledge representation combines physics with statistics and owner/operator experience thereby accounting for the physical characteristics of the wells, the equipment used therein, and well events (colloquially, “rocks, hardware, and operations”). The knowledge representation of embodiments is an open universe model which accounts for things that might (but don't always) happen during the life of a well. Thus, despite these events, systems of embodiments allow for production to be monitored and an alarm to be raised should a well fall below its predicted production.

Embodiments provide well analysis and forecasting methods which are unbiased, transparent, repeatable, and which execute rapidly on computers. These models can be fully automated and calibrated for use with oil, gas, water, etc. production. For instance, some methods can produce calibrated P10, P50, P90, etc. numbers. Instead of a single Estimated Ultimate Recovery (EUR) number, various methods produce histograms and outcomes which allow users to explore the probabilistic range of EURs. The P90 numbers (or ranges) provided by some methods enjoy a high degree of confidence (90%) that they will indeed be exceeded in a given time (such as 15 years).

Furthermore, the current disclosure provides tools for analyzing past, and forecasting future, well production. Many of these tools are based on the physical features of the well and on probabilistic treatment of historic production data. Moreover, embodiments reduce risks associated with production forecasts (both short term and long term) by providing a range of probabilistic production curves and by quantifying the uncertainty associated with these curves. Embodiments also, or in the alternative, safeguard trillions of dollars that would otherwise be exchanged based on outdated, manually manipulated decline curves. Owners, operators, national governments, etc. can use these production forecasts to value their reserves with reduced uncertainty.

The current disclosure provides methods for analyzing historic production data and for forecasting future production of oil wells which account for noise in the available production data and the shift of wells into new production regimes. These methods use probabilistic techniques to develop a model of the well (or a knowledge representation) from which an inference algorithm draws statistical samples of what the well production might have been and/or what the well production is likely to be in the future. In general, and in accordance with the current embodiment, many methods draw individual parameters from a knowledge representation and generate probabilistic production curves or “samples” of those production curves. Thus, rather than producing one fixed or deterministic model (that fails to account for probable events during the life of the well), methods of the current embodiment produce a range of possible decline (production) curves. From this population of decline curves, these methods produce statistics concerning the probability that the individual decline curves did match, or will match, the actual production. For instance, these methods can identify a P90 decline curve as well as decline curves associated with selected amounts of uncertainty.

Probabilistic inference systems provided by embodiments are both well parameterized and well calibrated. More specifically, the models incorporated in these systems have a number of parameters which have proven to be neither too few nor too many for many wells. In other words, the production curves they produce have a level of complexity that is neither too simple (and inaccurate) nor too “high-end” (requiring relatively large computing resources). Regarding their calibration, while probability distributions are used to characterize the equations and/or their parameters, the types of equations used in the models were determined with a relatively high precision by experienced statisticians using actual well data from oil, gas, and water producing wells.

Moreover, in accordance with embodiments, the current disclosure provides a physically-based, probabilistic (well) production, analysis system (PPAS). The PPAS of the current embodiment can be used to probabilistically determine past well production as well as forecast future production based on noisy historic data regarding the production of a given well(s). That input production data can come in the form of production records of oil, gas and/or water produced by a well (possibly, but not necessarily, including other relevant production information such as well pressure, choke, stimulation and/or shut-in time durations).

The PPAS of the current embodiment uses a physically-based probabilistic knowledge representation combined with a statistical inference algorithm to search for production models which have relatively high probability of being accurate and which are consistent with the observed data. These probabilistic models can then be projected forward to make future production forecasts and/or estimated ultimate recovery (EUR) forecasts. Not only can the PPAS of the current embodiment explain past production, but it is also capable of explicitly modeling features suggested by the production record such as shut-ins, well stimulations and changes of production regime. It also has the capability to suggest the probability that particular future events (such as well stimulations) will occur. Furthermore, to reduce processing requirements, the PPAS of the current embodiment can use sparse sampling at/near suspected well events (in the production data) to detect, analyze, and/or model such events. For instance, the PPAS can predict flow regime changes, stimulations, etc.

The PPAS of the current embodiment generally comprises two components: a knowledge representation (KR) of the well and an inference algorithm (IA). In some embodiments, the knowledge representation models the physical nature of the well and/or statistical knowledge of the well in a statistical, open universe framework with a user-selected degree of mathematical rigor. More specifically, the knowledge representation can model physical features of the well using various physical parameters associated with a mathematical model of the well. The inference algorithm of embodiments uses the well model (the knowledge representation) to evaluate the possibility that various well-related events, scenarios, etc. occurred during the history of the well and the possibility that these events might occur in the future. Moreover, inference algorithms can be optimized to search over the probabilistic physical parameters to evaluate these possibilities. For instance, the inference algorithm can use sparse sampling to evaluate these potentialities.

If desired, PPASs can comprise interactive graphical user interfaces (GUIs) and can import or access the production data imported through spreadsheets, databases, relational databases, files, etc. These PPASs can generate spreadsheets, databases, relational databases, files, etc. as well as graphs, charts, plots, pictures, and/or other graphical renderings through which the generated data can be output, uploaded, viewed, transmitted, evaluated, etc. Moreover, while various PPASs can execute on particular computers (for instance, a laptop computer), distributed, Internet-based, “cloud-based,” etc. computing systems can be employed to execute such PPASs.

Embodiments provide computer readable storage media storing instructions which when executed by a processor cause the processor to perform methods comprising modeling a production of a well. Furthermore, such methods comprise determining probability distributions for physical parameters associated with the well by training the model of the well with sparsely sampled historic data pertinent to the production of the well. These methods also comprise determining posterior distributions for the sparsely-sampled model by sampling probability distributions associated for the physical parameters. The methods also output the posterior distribution for the sparsely-sampled model of the well. In some embodiments, the methods further comprise adding non-Gaussian (Laplacian) noise to the sparsely-sampled model.

Various embodiments provide computer readable storage media storing processor executable instructions which when executed by the processor cause the processor to perform methods comprising modeling a production of a well and determining physical parameters associated with the well. Probability distributions for those physical parameters are determined by training the statistical model with historic data pertinent to the production of the well. Such methods also comprise determining posterior distributions for the model by sampling the probability distributions for the physical parameters. Adding non-Gaussian (Laplacian if desired) noise to the sparsely-sampled model and outputting the posterior distribution for the model of the well are included in such embodiments.

Some embodiments provide methods for modeling the production of various wells using processors. In some embodiments, the methods comprise modeling a production of a well. Furthermore, such methods comprise determining probability distributions for physical parameters associated with the well by training the statistical model with historic data pertinent to the production of the well. Such methods also comprise determining posterior distributions for the model by sampling the probability distributions for the physical parameters. Additionally, these methods comprise determining a posterior distribution for a future production of the well using the posterior distributions for the model of the well. Of course, these methods further comprise outputting the posterior distribution for the future production of the well based on the posterior distribution for the well.

In accordance with some embodiments, the model of the well is based on Bayesian statistics. Methods can also comprise adding Laplacian noise to the model of the well in accordance with geophysical properties thereof. In the alternative, or in addition, methods can comprise modeling a financial model of the well based on at least the posterior distribution for the model of the well. Some methods comprise using Markov Chain Monte Carlo sampling to converge on the posterior distributions for the model. If desired, an estimated ultimate recovery (EUR) estimate for the well can be determined. Quantifying an uncertainty associated with the posterior distribution for the future production of the well can be included in various methods. In some methods the training of the model of the well further comprises using historical data associated with an initial completion of the well, a shut-in of the well, a secondary stimulation of the well, or a combination thereof. The posterior distribution for the future production of the well is compared to a manually fit production forecast in some methods. Also, if desired, some methods comprise modeling multi-phase flow in the well using a model of a plurality of linked chambers in the well. Apparatus comprising interfaces, processors, and memories storing processor executable instructions for performing such methods are also provided.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other novel and nonobvious features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually corresponds to the figure in which the reference number first appears. The use of the same reference numbers in different figures usually indicates similar or identical items.

FIG. 1 illustrates a system for modeling wells.

FIG. 2 illustrates a knowledge representation of a well.

FIG. 3 illustrates a knowledge representation of a production forecast for a well.

FIG. 4 illustrates a histogram showing the time-to-peak in various wells.

FIG. 5 illustrates a gamma distribution of peak-production data.

FIG. 6 illustrates a histogram of a first well decline coefficient.

FIG. 7 illustrates a second well decline coefficient modeled as an exponential distribution.

FIG. 8 illustrates a graph of the relative production decreases during down pulses.

FIG. 9 illustrates a graph of the time-to-lowest-production after down pulses.

FIG. 10 illustrates a graph of time-to-peak data modeled as an exponential distribution.

FIG. 11 illustrates a graph of time-to-peak data modeled as a discrete distribution.

FIG. 12 illustrates noise modeled using a Laplacian Distribution.

FIG. 13 illustrates a well forecast.

FIG. 14 illustrates a predicted well stimulation.

FIG. 15 illustrates a comparison between a well production (distribution) forecast and well test data.

FIG. 16 illustrates a net present value prediction for a well.

FIG. 17 illustrates predicted anomalous production after well shut-ins.

FIG. 18 illustrates estimated flow modes within a well.

FIG. 19 illustrates a method of modeling well production.

FIG. 20 illustrates another method of modeling well production.

FIG. 21 illustrates some percentile accuracies of a method of modeling well production.

FIG. 22 illustrates a flowchart of a method for physically-based financial forecasting.

FIG. 23 illustrates a knowledge representation of a physically-based, probabilistic, financial model.

FIG. 24 illustrates a graphical user interface for entering physically-based production data into a system.

FIG. 25 illustrates a graphical user interface for conducting physically-based financial forecasts.

FIG. 26 illustrates another graphical user interface for outputting physically-based financial forecasts.

FIG. 27 illustrates yet another graphical user interface for outputting physically-based financial forecasts.

### DETAILED DESCRIPTION

This document discloses systems, apparatus, methods, etc. for performing physically-based well-financial analyses and/or forecasting and, more specifically, for performing physically-based well-financial analyses and forecasting using Bayesian statistics, sparse sampling, and Laplacian, Gaussian, and/or other forms of noise to analyze and forecast physically-based financial performance of various petrochemical wells.

Embodiments provide physically-based probabilistic, analysis/forecasting systems, apparatus, and methods. Such systems can provide more accurate analyses and/or forecasting for production from various wells) such as those which produce water, oil, natural gas, other petrochemicals, etc.) than heretofore available. Some analysis systems include a knowledge representation of the well(s) which are in communication with an inference algorithm. These systems receive inputs from available data sources and return outputs in relatively easily understood format. These systems can be run on single computers, distributed networks, tablets, smartphones, or other computing devices. In some situations, servers can host the systems with users accessing the systems via client devices and/or networks.

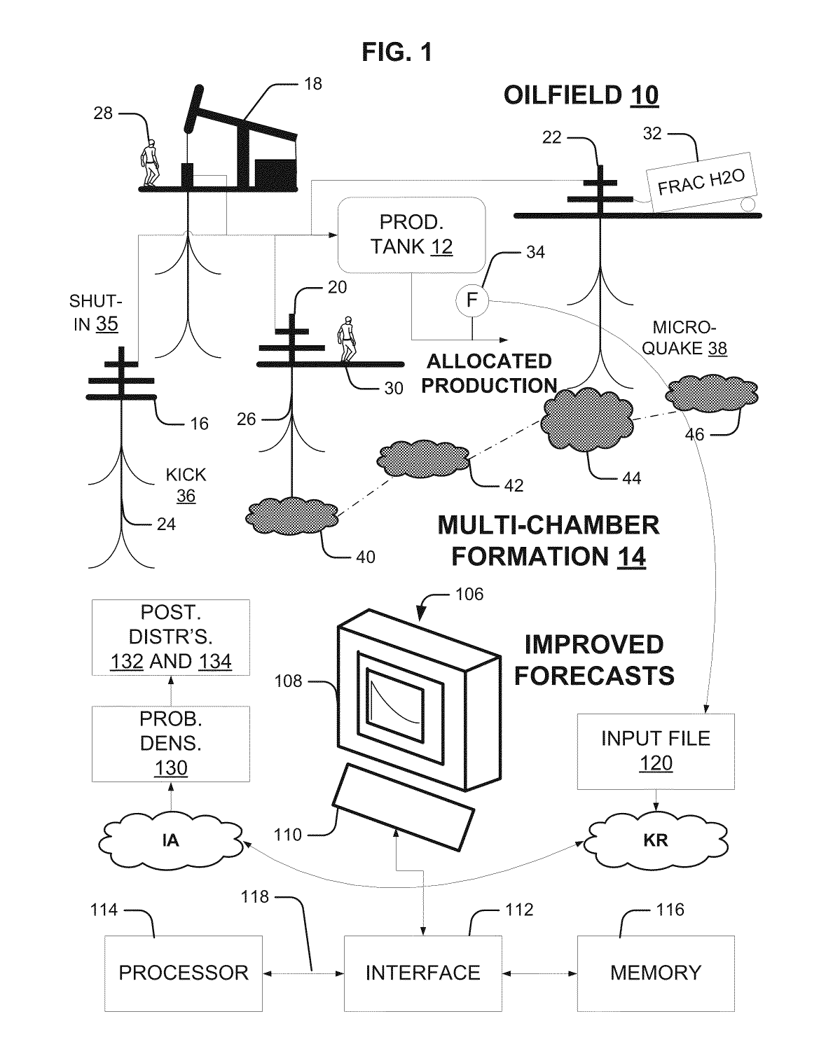

FIG. 1 illustrates a system for modeling wells. More specifically, FIG. 1 illustrates an oilfield 10, a production tank 12, a multi chamber formation or well 14, wellheads 16, 18, 20, and 22, well bores 24 and 26, well testers 28 and 30, a frac tank 32, a flow meter 34, a “kick” 36, a micro-quake 38, and chambers 40, 42, 44, and 46. FIG. 1 also illustrates a system 100, a computer 106, a display 108, a keyboard 110, an interface 112, a processor 114, a memory 116, a bus 118, a production input file 120, a knowledge representation (or well model) 122, an inference algorithm 124, probability densities 130, model posterior distribution 132, and forecast posterior distribution 134.

With continuing reference to FIG. 1, oilfields 10 represent a source of wealth, value, revenue, income, etc. to their owners, operators and others (i.e., users) who might have invested therein or otherwise have an interest therein. It might cost many millions of dollars to develop an oilfield 10 for which the initial exploration represents only a fraction of that investment. Following exploration (during which these parties attempt to quantify the amount of recoverable oil, other petrochemicals, water, fluids, etc. present “in” the field), they might invest millions (or even billion) more in developing the oilfield 10. For instance, these parties typically identify and map the formations that likely bear these fluids (and/or “petrochemicals”). Moreover, they also typically identify (from telltale clues provided by the formations) well 14 sites likely to produce fluids in sufficient volume to provide an economic return on investment. They then drill wells 14 in anticipation of profits from selling or otherwise using the produced fluids petrochemicals.

If they made wise investments, the wells 14 begin producing at or above a particular volume or flow rate often termed a “P90.” P90, of course, refers to that anticipated time-varying flow rate which the well 14 will equal (or exceed) as actual production commences (or continues). If the well 14 exceeds its estimated P90, the owner/operators (having likely based their financial plans on that P90) will probably enjoy a profit. If the actual production of the well 14 falls below its estimated P90, the owners stand likely to realize a negative return on their investment. They suffer a loss. Thus, determining a “good” P90 number has been of significant interest to those involved in oilfield 10 exploration, development, operations, etc. Companies, moreover, often succeed or fail based on their ability to determine P90 correctly—taking their employees, investors, and the like with them one way or another.

Yet, a P90 figure (as such) might be somewhat misleading. Any particular well 14 will not produce according to a single, fixed, and/or deterministic flow rate. Many variables, too numerous to enumerate herein affect the actual production of the well 14. While the art does not seem to recognize it, the inventors have realized that P90 (and/or the actual production) of the well can be characterized as a probabilistic concept. In other words, P90, the historic production, and/or the future production of a well 14 can be viewed as a time varying figure with a probable time-varying range (at any given time). Further still, the production of a well 14 can be characterized over time by a graph something akin to a function wherein that function (or equation) has various terms including various parameters. Each of the parameters can be treated as a range of values with a probabilistic distribution. Determining the probabilistic ranges for the parameters (and/or terms) thus leads, in accordance with embodiments, to posterior distributions for those parameters. These posterior distributions (for the parameters) can be used to identify (probabilistic) historic productions as well as to forecast (probabilistic) future production.

Still with reference to FIG. 1, some of the reasons that even the historic production of the well 14 can be viewed as a probabilistic time varying number is that, in many cases, that actual time varying number cannot be readily determined. In the alternative, or in addition, so much noise might be associated with the actual time-varying, historic production that drawing meaningful conclusions regarding what the true historic production of the well is/was represents a heretofore insurmountable challenge. Embodiments provide methods, systems, apparatus, etc. which at least provide aid in overcoming those challenges and/or perhaps others.

Having discussed such considerations of typical wells 14, it might now be helpful to consider a typical oilfield 10 and related computer 106. See FIG. 1. Such oilfields 10 occur in many locations worldwide and parties interested therein discover more oilfields 10 with each passing day. They occur in desert regions, artic regions, on-shore, offshore, “in” (i.e., above) shale deposits, in sedimentary basins, and in many other environments. Some oilfields 10 happened to be suspected, known, explored, developed, depleted, etc. to differing degrees. At some stage of their life, though, many of them sometimes reach a stage such as that illustrated by FIG. 1. In FIG. 1, the oilfield 10 includes a number of wellheads 16, 18, 20, and 22. Each of the wellheads 16, 18, 20, and 22 has installed therein various production (and/or exploration) equipment such as blowout preventer stacks (BOPS) or more broadly “Christmas trees,” pumps (see wellhead 18), and stimulation equipment (see for instance frac tank 32 at wellhead 22).

The owner/operators often route the production (or outflow) of various wells 14 to a common production tank 12. The production tank 12 of various embodiments provides a common place at which the production of many wells 14 can be collected for transmission and/or transport to refineries and/or other points of use. While reasons vary for routing the production of many wells 14 to one common collection point, one reason for doing so is that many wells 14 in a geographic region happen to be commonly owned or at least subject to some common royalty, licensing, or other assignment-related arrangement. Thus, for the owner/operators it sometimes makes sense to provide such a common collection point. For such reasons, oilfields 10 often have one common flow meter 34 which makes actual measurements of the cumulative production of many wells 14. But, in some situations, ownership of the oilfield 10 might be fragmented. Thus, the cumulative production of an oilfield 10 can be allocated (often as a matter of convenience) amongst the various wells 14 that flow to the production tank 12.

In other words, each well 14 is said to be “allocated” some fraction of the cumulative production at (or downstream of) the common collection point or production tank 12. Indeed, in many oilfields 10, the flow meter 34 is positioned downstream of the production tank 12 to measure the cumulative flow therefrom. Yet, while the flow meter 34 might/might not provide accurate measurements of that cumulative production, it simply cannot account for allocation-related inaccuracies. Nor can it account for sources of inaccuracy in how its measurements are subsequently handled (assuming those measurements are accurate or taken at all).

Still with reference to FIG. 1, many oilfield 10 owner/operators attempt to minimize allocation errors by, for instance, performing (periodic) “well tests” at the wellheads 16, 18, 20, and/or 22. During a typical well test, reservoir engineers attempt to acquire data regarding the ability of a well 14 to produce the petrochemicals for which it was developed. Data gathered often includes well pressure and/or well flow rate (whether volumetric, weight-based, or otherwise) or the well's ‘production.’ In theory, a well test therefore allows the owner/operators to adjust the allocated production for each well 14 delivering petrochemicals to a given point of collection.

In practice, the outcome might differ from theory. For one thing, well tests between different wells 14 might differ in accordance with who owns (and/or controls) the well 14 in question. Additionally, differing well testers 28 and 30 might perform even (ideally) identical well test procedures on even the same well 14 in different manners. Results would, of course, vary. For instance, one well tester 28 might round results up to the nearest 1000 barrels/day while another well tester 30 might round results down to the nearest 100 barrels/day. Moreover, some wells 14 might or might not be tested on a regular basis or at all. Further still, some well testers 28 might care greatly about their performance and provide accurate results, while other well testers 30 might care relatively little about their performance thereby providing results of dubious reliability. For instance, suppose a particular well tester 30 simply copied and submitted a previous well-test report from when a well 14 was (for a time) shut-in. As a result, while the allocated (and even adjusted) production for the various wells 14 might accurately reflect the actual production of each of the wells 14, it is probably the case that the allocated production for any given well 14 could be wildly inaccurate. Yet it is these numbers that various users employ in judging historic, current, and/or forecast production numbers for the wells 14 involved. Thus, production estimates for any given well 14 and/or related oilfields 10 can be subject to noise which is difficult to quantify.

At this juncture, it might be helpful to consider some other typical features of an oilfield 10. For instance, FIG. 1 illustrates that it is believed that many wellheads 20 draw fluid from subterranean, multi-chamber wells 14. These formations include one or more chambers 40, 42, 44, and 46 which are in fluid in communication with one another (and the wellhead 20). Of course, fluid communication here is something of a relative term. The chambers 40, 42, 44, and 46 are unlikely to be large voids in the surrounding rock (or other earthen materials). Rather, the chambers are more likely to be volumes within the rock wherein the rock exhibits a high degree of porosity. The connections between such “chambers” are also likely to be permeable regions rather than caves although a mixture of such features could be present in any given multi-chamber 40, 42, and/or 44 formation.

The presence of a multi-chamber formation in a given well 14 is likely to contribute to the noise associated with that well 20. This result is so, because as the various fluids (which might partially or entirely separate from one another) migrate or flow through the multi-chamber well 14, their interaction with the chambers 40, 42, and/or 44 could cause the composition of the “oil” produced by the well 14 to vary. For instance, oil in one chamber 40 might become momentarily depleted allowing a volume of water from another chamber 42 to enter the well bore. As a result, the “production” of well 14 might change to a more heavily water-loaded mixture than before/thereafter. Moreover, the flow rate of that overall mixture (and/or the amount of true oil therein) might also vary. As a result, production forecasts which fail to take into account the potential multi-phase, multi-chamber nature of at least some wells 14 might be less accurate than would otherwise be the situation. This is true, at least in part, because natural “flow regime changes” can and do occur because the various chambers have different inherent sizes, permeabilities, etc. Each one therefore contributes differently to the overall production of the well(s) to which they flow

Moreover, the physical factors of some wells 14 and or wellheads 18 might cause a phenomenon known as “kick.” A kick 36 occurs when the pressure in the well formation exceeds the pressure imposed in the well bore 24 by the column of drilling (and/or other) fluids therein. A net and potentially uncontrollable flow into the well bore 24 can develop which, if unchecked, could lead to a relatively large leakage. Thus, owner/operators often install blowout preventer (BOP) stacks on the “Christmas trees” of various wells 14. If these owner/operators detect or suspect that a kick 36 has begun or that a well 14 threatens a kick 36, they can use the BOP stack to shut-in the well 14. Of course, while the shut-in 35 persists, no or little production occurs at the affected well 14. If the allocated production of the oil well 14 fails to take the shut-in 35 into account, yet another source of noise injects itself into the production history of that well 14. Moreover, in an allocation scheme, that decreased production might be attributed to other commonly collected wells 14.

FIG. 1 also illustrates yet another source of noise related to the production of various wells. Under a number of scenarios, oilfield owner/operators find it desirable to stimulate further production in particular wells, oilfields 10, or portions thereof. For instance, as wells 14 produce petrochemicals it often occurs that the pressure in the well formation drops accordingly. This pressure drop in turn leads to reduced production (flow) from the affected well 14 making the well less economic to operate. Thus, the owner/operator of that well 14 might inject gas, water, or other fluids into the well to increase the pressure thereby (hopefully) driving more production from the well 14.

For instance, lately, hydraulic fracturing has fueled “booms” in oilfields 10 in (inter alia) the Bakken and Eagle-Ford shale formations in respectively North Dakota and Texas. Hydraulic fracturing often involves pumping pressurized fluids into a well drilled into an oil-bearing shale formation. Ordinarily, the relatively impermeable, non-porous shale in such formations traps the petrochemicals present in the formation. However, the pressurized fluid forced into the wellbore of such wells flows into small cracks in the shale. As it does so, it exerts a force on the surfaces of the crack. Eventually, the shale fractures creating a network of cracks near each such fracture. The pressurized fluid conveys solid “proppant” into the cracks which wedges the cracks open even after pressure is removed. As a result, the permeability of the shale formation increases significantly allowing more production than would otherwise be the case. FIG. 1 illustrates such operations via frac tank 32.

One perhaps interesting feature related to fracking is the occurrence of so-called micro-quakes 38. Micro-quakes 38 occur when a particular piece of shale (or other rock earthen material, etc.) fractures during fracking. Each such fracture event represents a release of a relatively small amount of energy. Indeed, that released energy is typically about the energy released by metabolizing a chocolate bar. Some of the released energy propagates through the shale formation in the form of a pulse of sound. As such, this sound energy, or micro-quake, can be monitored by seismic exploration equipment which allows various algorithms to map the formations through which this sound propagates. This mapping, in turn, can be used to improve various mathematical models (or knowledge representations) of the fracked well.

In accordance with embodiments, production data can be gathered from the oilfield 10, the common flow meter 34, and/or various wellheads 18, 20, and/or 22. That production data can be incorporated into a data file for input into the computer 106 for analysis, storage, re-transmission, etc. That input file 120 can take any form capable of storing, transmitting, etc. the production data. For instance, it could be a spreadsheet, a series of tables in a relational database, an Internet (or Cloud) streaming source, etc.

With regard to analysis of the production data in the input file 120, computers 106 of some embodiments host the knowledge representation 122 and/or the inference algorithm 124. Together, they work to respectively model the physical structure of a well or wells 14 and determine probabilistic historic production estimates and probabilistic production forecasts. Moreover, these modules, programs, algorithms, etc. can be designed together to, for instance, account for peculiarities which one or more owner/operators might want to model. For instance, it occurs from time-to-time that owner/operators might have come to recognize a category of well 14 that behaves in some distinguishing manner. For instance, despite the likelihood that the production of most wells 14 will decline with time (other factors being equal), some wells 14 “just keep producing no matter what.” For another instance, some knowledge representations 122 can model multiple stratigraphic horizons, time-dependent permeability, customized warnings, aggregate production data from multiple wells, national reserve valuation, etc. The knowledge representations 122 and inference algorithms 124 of embodiments can be designed together to account for such user-identified analysis/forecasting issues.

The knowledge representation 122 of embodiments produces probability distributions of the well's physically-based parameters. Meanwhile, the inference algorithm samples those probability distributions to converge on posterior distributions for these physically-based parameters of the well model (i.e., the knowledge representation 122) which describes the behavior of the well 14. In doing so, the inference algorithm 124 can use any of the available statistical sampling methods (for instance, Markov Chain Monte Carlo sampling) and/or those that will arise in the future. Using these physically-based parameters (and/or their posterior distributions), the inference algorithm 124 can project backward/forward in time to give posterior distributions for the likely production of the well 14 at any user-selected time(s) and/or period(s).

Still with reference to FIG. 1, the knowledge representation 122 of the current embodiment is a series of subroutines and/or mathematical models which probabilistically describe the physical structures of a well 14 and other factors pertinent to its production (such as those disclosed herein) and the statistical/probabilistic relationships there between.

The knowledge representation 122 of embodiments can be used in conjunction with other production estimating, forecasting, predicting, etc. techniques. For instance, supplementary production forecasts can be made using various decline curve analysis tools/approaches. Many of these approaches fit “smooth” curves described by relatively simple equations to available production data. These equations are often hyperbolic, elliptical, etc. in nature and one such tool in common use is the Arps tool. However, these “fit” curves usually need to be manually adjusted to attempt to account for noise in the available production data. Making these manual adjustments usually requires years of experience, introduces subjectivity to the analysis, and allows room for argument as to the accuracy of the adjusted results. For instance, these manual adjustments depend on, and can be skewed by, the opinions and/or objectives of the user who made them. Methods provided herein often out perform such subjective methods. For example, it is common practice to adjust a curve so that it returns an EUR which was assigned to a well by other means. In affect, this forces the data to fit a pre-conceived notion, a practice of perhaps dubious value.

For another instance, type curves can be used to guide/begin some production analysis. On that note, for many wells 14, production can be expected to be similar to the production of other wells 14 in the same oilfield 10, play, region, etc. Thus, users can develop a type curve for the new/modified well 14 by averaging available production data from these other supposedly similar wells 14. The production for that given well 14 is then estimated by multiplying the type curve for the new well's locale by factors which represent the initial production and/or the new well's geometric/geophysical configuration to arrive at a curve supposedly representative of the production which might be expected from that well 14. However, wells 14 can be expected to differ from one another. For instance, the thickness of their pay zones might differ, they might have different well treatments, initial productions might vary, etc. Users might therefore need to make manual adjustments to the type curve to account for these differences. As a result, errors, inconsistencies, omissions, etc. can occur leading to inaccurate and/or unreliable results. Moreover, usually, users develop type curves over extended periods of time which enjoy, to some extent, quasi steady state production. While type curves can be used with embodiments, the use of type curves is not necessary for practicing many embodiments.

In contrast to the use of type curves, methods provided herein can use production data from the initial ramp up of a well 14 which might reflect many shut-ins and/or other non steady state well-events (that would produce misleading results with heretofore available approaches). Even in the presence of that noise, methods provided herein do not become confused and can relatively accurately predict the beginning of the declining portion of a decline curve for a well 14. Note also that, once an inference algorithm 124 produces a (probabilistic) decline curve for one or more wells 14 in an oilfield 10, that decline curve can be used as a type curve for other wells 14 in the oilfield 10.

In addition, or in the alternative, history matching can be attempted for a particular well 14 in conjunction with methods disclosed herein. History matching entails setting up a relatively complex, yet fixed and/or deterministic, numerical model of a well 14 and finding a fixed set of parameters which cause the results of the deterministic model to (more or less) match the available production data however noisy it might be. Note that history matching results in one fixed/deterministic equation that does not necessarily account for noise, operational considerations, the probabilities that various well-related events will occur, etc.

Moreover, history matching is not probablistic. It returns only one answer. In history matching, a deterministic model is built and, therefore, it always gives that same answer. The knowledge representation 122 of embodiments yields different outcomes every time its run because it draws many of its parameters from probability distributions in contrast to running inputs through fixed equations. Moreover, one difference between such deterministic models and generative models (or, in the current embodiment, the knowledge representation 122) is that deterministic models accept their inputs (such as permeability, formation thickness, etc.), run, and deliver one answer. In contrast, generative models execute and produce many reasonable production curves by drawing on its “priors” or statistical models. Indeed, the number of production curves that a generative model might product is limited only by the number of permutations of the parameters therein, their values, and the time available for execution.

Used alone, manual curve fitting, type curves, and even history matching can leave errors and/or discrepancies in the expected production. Since these errors accumulate over time, even small errors can lead to huge discrepancies in the cumulative production and/or EUR of the well 14. The errors inherent with heretofore available approaches can also affect the projected economic life time of a well 14 (or other project) thereby introducing risk into owner/operator planning over and above that associated with moves in the price of oil and/or other produced fluids. Embodiments usually reduce such errors leading to more accurate production and/or EUR forecasts in many situations. Computer applications, programs, etc. incorporating methods of embodiments and related services, apparatus, systems, etc. are available from BetaZi, LLC.

Still with reference to FIG. 1, a few words might be in order about the computer(s) 106 and/or other systems, apparatus, etc. used to design, store, host, run, execute, etc. knowledge representations 122 and/or inference algorithms 124 of embodiments. The type of computer 106 used for such purposes does not limit the scope of the disclosure but includes those now known as well as those which will arise in the future. But usually, these computers 106 will include some type of display 108, keyboard 110, interface 112, processor 114, memory 116, and bus 118.

Furthermore, any type of human-machine interface (as illustrated by display 108 and keyboard 110) will do so long as it allows some or all of the human interactions with the computer 106 as disclosed elsewhere herein. Similarly, the interface 112 can be a network interface card (NIC), a WiFi transceiver, an Ethernet interface, etc. allowing various components of computer 106 to communicate with each other and/or other devices. The computer 106, though, could be a stand-alone device without departing from the scope of the current disclosure.

Moreover, while FIG. 1 illustrates that the computer 106 includes a processor 114, the computer 106 might include some other type of device for performing methods disclosed herein. For instance, the computer 106 could include an ASIC (Application Specific Integrated Circuit), a RISC (Reduced Instruction Set IC), a neural network, etc. instead of, or in addition, to the processor 114. Thus, the device used to perform the methods disclosed herein is not limiting.

Again with reference to FIG. 1, the memory 116 can be any type of memory currently available or that might arise in the future. For instance, the memory 116 could be a hard drive, a ROM (Read Only Memory), a RAM (Random Access Memory), flash memory, a CD (Compact Disc), etc. or a combination thereof. No matter its form, in the current embodiment, the memory 116 stores instructions which enable the processor 114 (or other device) to perform at least some of the methods disclosed herein as well as (perhaps) others. The memory 116 of the current embodiment also stores data pertaining to such methods, user inputs thereto, outputs thereof, etc. At least some of the various components of the computer 106 can communicate over any type of bus 118 enabling their operations in some or all of the methods disclosed herein. Such buses include, without limitation, SCSI (Small Computer System Interface), ISA (Industry Standard Architecture), EISA (Extended Industry Standard Architecture), etc., buses or a combination thereof. With that having been said, it might be useful to now consider some aspects of the disclosed subject matter.

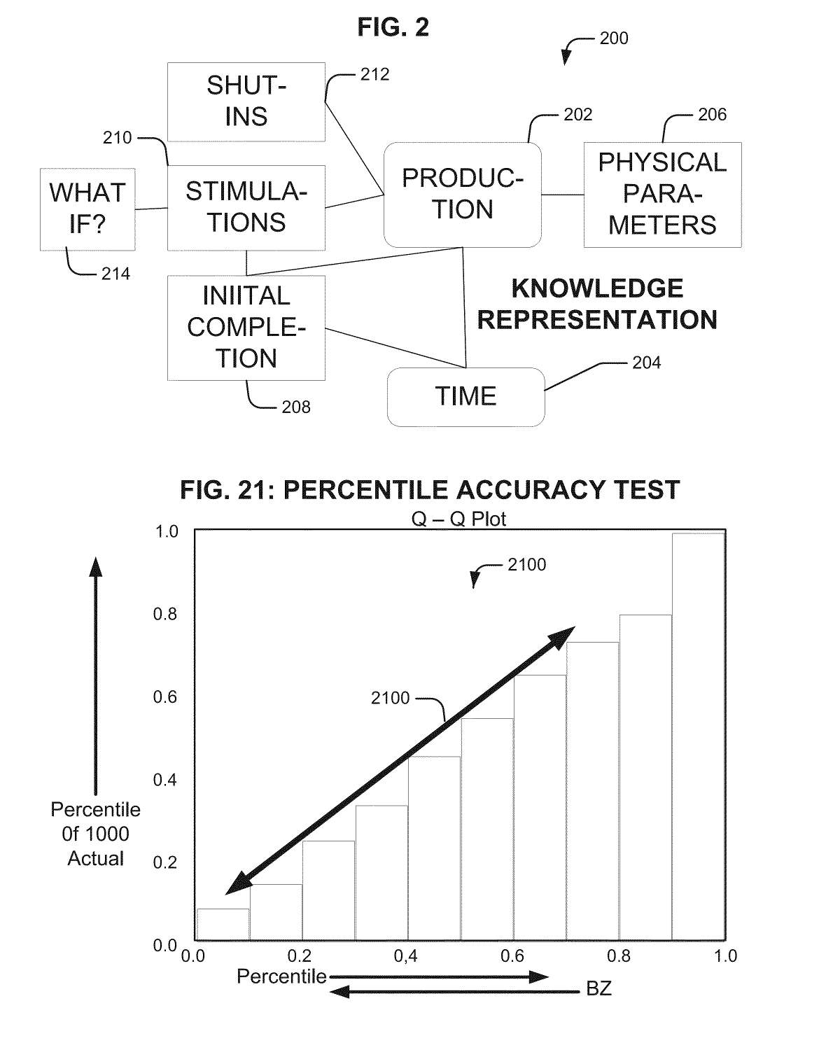

FIG. 2 illustrates a knowledge representation of a well. The knowledge representation 200 of the current embodiment is an open universe, generative model and is configured to probabilistically analyze and/or forecast production of many wells 14. Moreover, in some embodiments, the knowledge representation 200 of the well 14 can be based on Bayesian statistics, the Dempster-Schafer theory, and/or similar mathematical concepts as well as physical laws and their related equations. The knowledge representation 200 could be based on a generalized graphical model, i.e. not necessarily a directed graphical model that is typical of many generative models. It could also be optionally expressed using one of the many languages available for such purposes. For example BUGs (WinBUGS), iBALL, Church, BLOG (BayesianLOGic), and/or Alchemy. With reference again to FIG. 1, the knowledge representation 200 can model an abstraction of the fluid and/or gas flow of multiple production regimes by using Boyle's and Darcy's (and/or other) laws to predict fluid flow in a well 14. Thus, the knowledge representation 200 can model the flow in the well 14 as if various gases and/or liquids are flowing through multiple, linked chambers 40, 42, and/or 44.

The knowledge representation 200 models (inter alia) the production 202 of the well 14, time 204 (into production), various physically-based parameters 206 of the well 14, the initial completion 208 of the well 14, secondary stimulation(s) 210 thereof, its shut-ins 212 (if any), and various potential what-if scenarios 214. Of course, the knowledge representation 200 could model a different mix of factors if desired. For instance, the knowledge representation could include factors and/or parameters pertinent to choke size, fluid pressure, multi-phase production, rock permeability, pay zone thickness, formation porosity, fracture length and geometry, adsorption, well geometry, etc.

From a physical perspective, the well's modeled production 202 depends on physical factors of the well 14 for which the knowledge representation 200 includes physically-based parameters (in various user-selected/user-determined equation types) modeling those physical factors (i.e., physically-based parameters 206). That production (in the real world and analytically) often depends on conditions present at the as-modeled initial completion 208 of the well. For instance, the initial well pressure often contributes to the determination of the peak of a well's decline curve. That decline curve usually tails off in an exponential manner with the current value relating back to the initial production (whether the timing of the initial completion 208 is known or not). Other production-related (or potentially production-influencing) factors and/or events might also affect the real-world production of the well 14. Accordingly, the knowledge representation 200 of the current embodiment can model these other factors. For instance, both secondary stimulations 210 (for instance, multiple-stage, initial simulations) and shut-ins 212 might occur in the real-world and can be modeled accordingly in the knowledge representation 200 if desired.

In the real-world, each of these factors can affect the production of the well 14. Thus, the knowledge representation 200 models them thereby linking the underlying physical phenomenon and the statistical/probabilistic techniques incorporated in the knowledge representation 200 of embodiments. The underlying physical formulas and probabilistic techniques thus involve certain physically-based parameters which can be found by training the knowledge representation 200 of various embodiments with historic production data. Moreover, the knowledge representation 200 of the current embodiment posits that the decline curve for a well 14 generally has a shape described by a plurality of decaying exponential curves augmented by various “pulses.”

Those pulses can be caused by a variety of circumstances. For instance, should an owner/operator shut-in a well 14, the pressure in the well 14 will usually rise (while production is negligible) thereby enabling a production surge (or pulse) when the owner-operator returns the well 14 to production. In other circumstances, the well 14 might suffer a leak of sorts depending on the amount of production forfeited. For instance, some leaks might cause oil to be captured in a retention pond rather than fed to the common collection point or into the production stream. Production, for the affected well 14, would likely fall as a result. On the other hand, should the well 14 be stimulated, its production might increase in the long run. Of course, during the lifetime of a well 14 certain events might precipitate other pulses, temporary production losses/declines, and/or anomalous production.

Most pulses, whether positive or negative and according to embodiments, can be treated as a term(s) of an equation and which has various parameters reflecting the physical features of the well. Statistics describing those physically-based parameters (and/or terms) can be extracted from available (and noisy) production data) by training the knowledge representation 200 with that historic production data. For instance, probabilistic ranges for those parameters can be identified and used to forecast future production (and/or to estimate past production) and/or probabilistic ranges there for.

Perhaps, at this juncture, it might be helpful to discuss, in general, probabilistic interference models such as those illustrated by FIG. 2. In these models, each node (for instance, production 202, physically-based parameters 206, etc.) contains directions for computing its value (and/or probability) based on values in other nodes connected to it. Unconnected nodes are often conditionally independent given values in nodes pointing to them. Inference algorithms coupled to such models can determine the structure(s) of the model and the values of the various nodes given observable data regarding the modeled system, object, behavior, etc. Sampling such models also allows inference algorithms to quantify the uncertainty associated with these values.

Often, statisticians use the term “generative model” to describe methods in which attributes, variables, parameters, etc. of selected scenarios (also known as a “worlds”) are assigned specific values. Statisticians refer to this part of these methods as instatiating the parameters. Some instantiations can be deterministic. But others can be based on probability distributions or conditional probability distributions (CPDs) which are parameterized by the values of other already instantiated variables. Generative models in which there is no bound on the number of instantiated variables are often referred to as open-universe models.

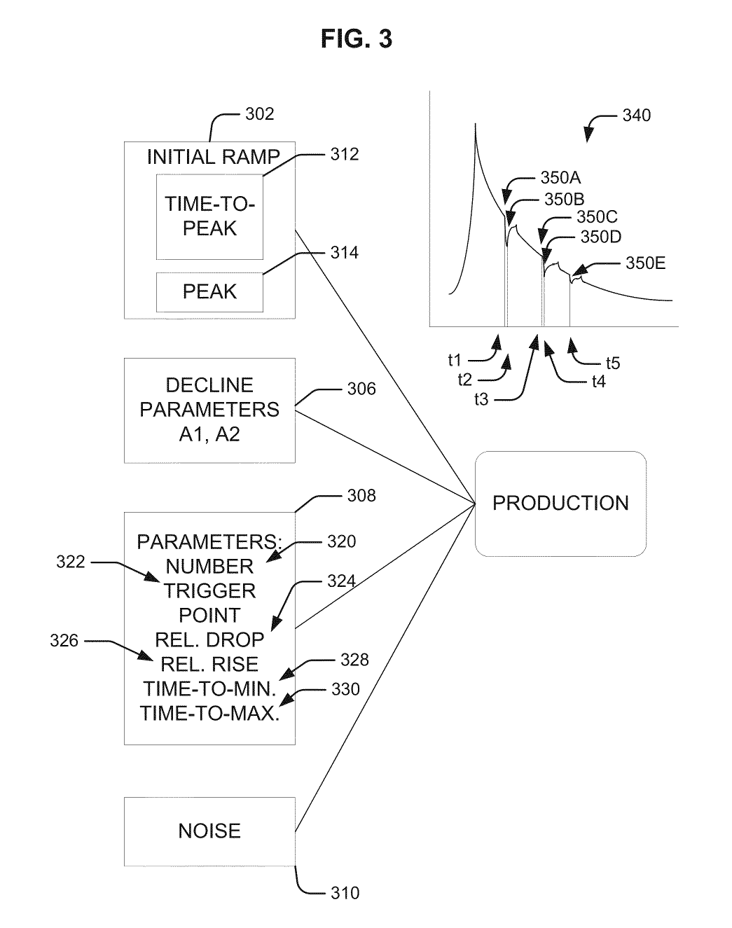

FIG. 3 illustrates a knowledge representation of the production of a well. More specifically, FIG. 3 illustrates a production 300, an initial ramp up 302, subsequent pulses 304, decline parameters 306, pulse parameters 308, noise 310, a time-to-peak 312 distribution, a peak production distribution 314, first decline coefficients a1, second decline coefficients a2, a number of pulses 320, their trigger points t1-t5, relative drops 324, relative rises 326, times-to-minimum 328, and times-to-maximum 330. FIG. 3 also illustrates a somewhat simplified production plot 340.

The production plot 340 reflects the likelihood that the time-varying production for a given well 14 is or will reflect a number of peaks 350 or troughs which follow/accompany various events during the life of the well 14. A ramp up will usually precede each peak 350 with declines often following those peaks 350. Of course, for troughs, the declines precede the trough with a ramp up following it. For instance, FIG. 3 shows five peaks 350A-E (and/or troughs) preceded by corresponding ramps and followed by corresponding declines 352A-E (when viewed one at a time). Moreover, each ramp up/decline will begin at a particular trigger point (or time) t1-t5. Of course, the production of a typical well 14 combines these peaks 350 into a piece-wise continuous production plot 340 which at any given time reflects the cumulative affects of all proceeding peaks 350 (along with the corresponding individual ramps and/or declines).

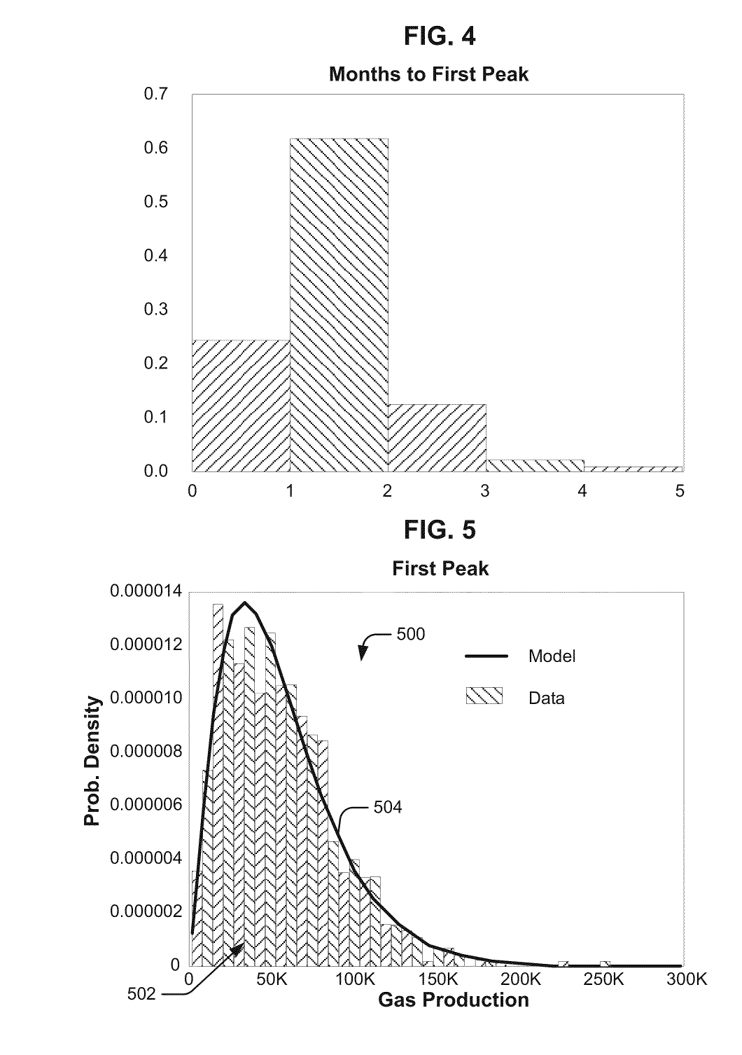

As noted elsewhere herein, FIG. 3 illustrates that for any given well 14, the knowledge representation 200 can model an initial ramp up 302 of its production 300. Ordinarily, the initial completion of the well 14 will trigger the initial ramp up 302 of production 300. However, it might be the situation that no (or little) historic production data might be available for a particular well 14, or that a well 14 is being, has been, or will be placed in production after a some lengthy period. In the alternative, or in addition, it might be the situation that an owner/operator has stimulated a well 14. In such situations, it might be appropriate to model and/or treat the first, subsequent pulse 304 as an initial ramp up 302. It might, furthermore, be appropriate to model these initial ramp ups 302 as linear functions with an unknown (but probabilistic) time-to-peak 312 distribution. For at least some wells 14, the collection of time-to-peaks 312 for a well 14 can be treated as a discrete probability distribution. FIG. 4 illustrates one such (historic) time-to-peak 312 distribution as it was learned from training data.

FIG. 5 illustrates a gamma distribution of peak-production data. The gamma distribution 500 illustrated by FIG. 5 includes the historic peak production data 502 as well as a plot 504 of the modeled data. Note that the height of each peak is usually independent of the time it took for the corresponding well 14 to reach that peak production. Taken together, the collection of peaks gives rise to the gamma distribution 500 and the physically-based parameters characterizing its shape, location, and scale. Of course, the peak production data 502 illustrated by FIG. 5 is a portion of the historic data used to train the knowledge representation 200 of the current embodiment. Thus, FIGS. 4 and 5 provide data related to the time to reach the first peak for a given well 14 as well as the peak production(s) reached by that well 14.

From the first peak, production for a large majority of wells 14 will decline in manners reflected in their corresponding decline curves. Corresponding decline (production) equations can be found by training the knowledge representation 200 with historic (training) production data for the well. The form (or shape) of the decline curve for a given well 14, of course, can be described by a decline equation including, but not limited to, hyperbolic, exponential, Aprs, elliptical and modified elliptical equations. Moreover, it has been found that decline equations which combine two (or more) exponential terms at various times during a well's production can be helpful in forecasting future production. For a two exponential term, two trigger point (initial production and a second trigger point) model, one potentially helpful decline equation is:

qt=q0(ê(−a1*t)+ê(−a1*p)*ê(−a2*t))/(1+ê(−a1*p)) Eq. 1
Where: t=time in production
q₀=initial production (flow rate)
a₁=first decline coefficient
a₂=second decline coefficient
p=trigger point for second decline term/coefficient

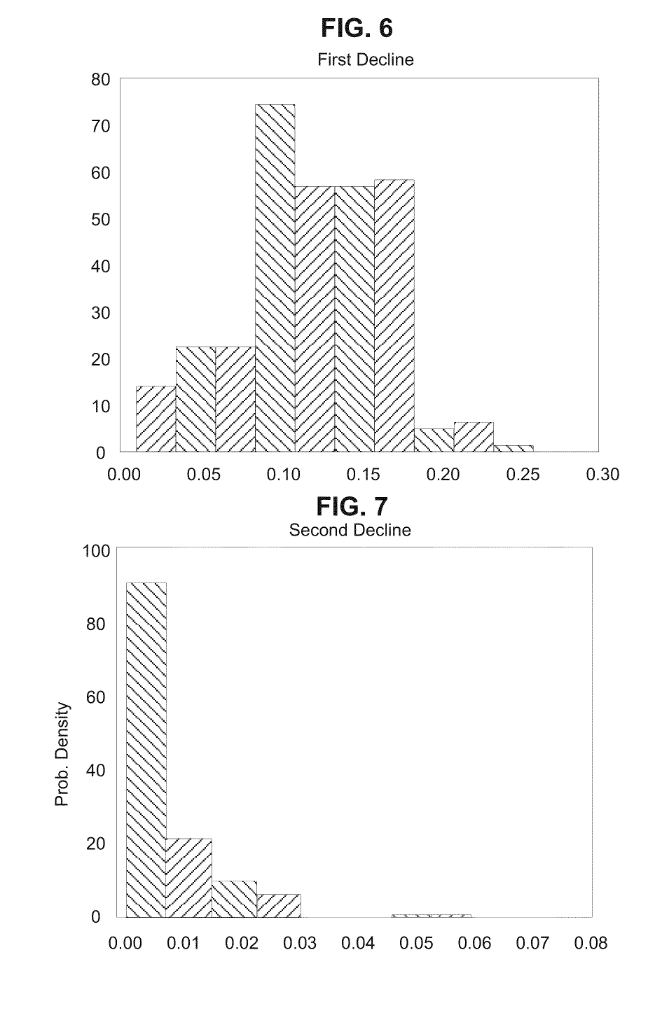

In Equation 1 of the current embodiment, the first decline coefficient a1 is modeled as having a Gaussian distribution (see FIG. 6) the coefficients of which are learned by training the knowledge representation 200 with historic production data. The second decline coefficient a2 is modeled as having an exponential distribution again with coefficients learned via training the knowledge representation 200. See FIG. 7. These decline coefficients a1 and a2 can be modeled as being independent of one another. However, that need not be the case. Rather, some data suggests that these decline coefficients a1 and a2 can exhibit a weak correlation. More specifically, some data suggests that they can have a correlation coefficient of approximately 0.2578 with a Pearson product-moment correlation coefficient (p-value) of 3e-7.

Regarding the pulses 320, the number of pulses 320 in a production sequence (or some other time frame during the life span of a given well 14) can be treated as a Poisson distribution. The average rate associated with that distribution could be parameterized by a monthly rate although other time frames (annual, weekly, etc.) can be used to define the rate. Moreover, the location of each pulse 320 can be modeled as being uniformly distributed over the production period.

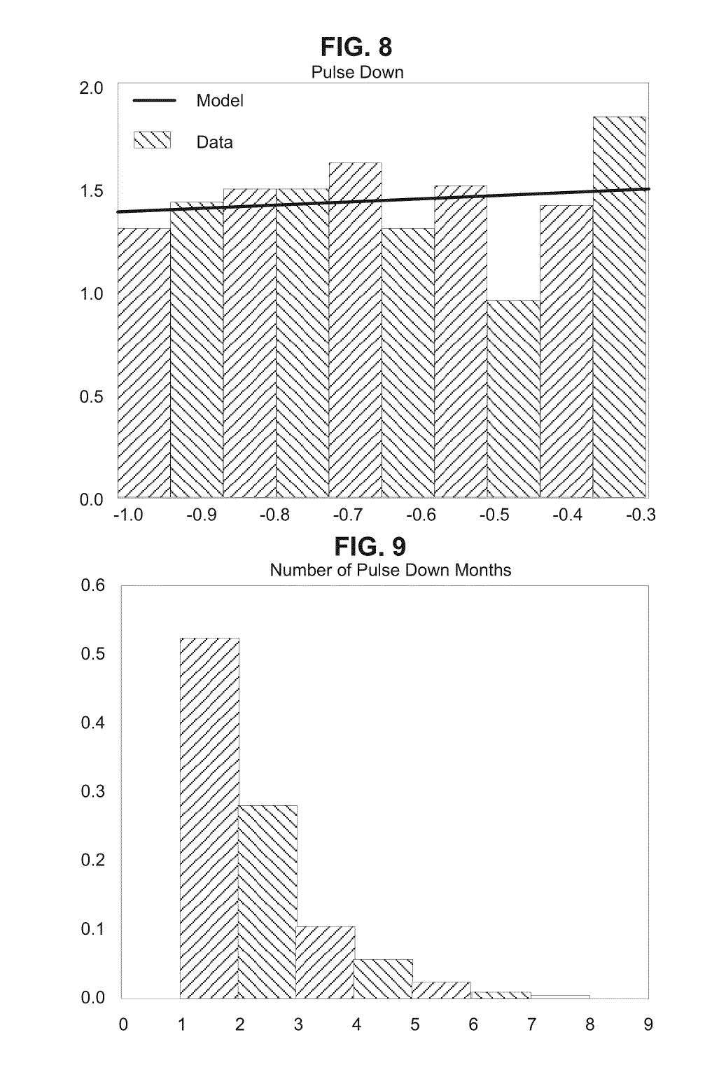

With reference again to FIG. 3, each pulse 320 can be modeled as including a down edge and an up edge. The relative drop 324 (rise) during a down pulse 320 can be modeled as having a linear distribution between, in some situations, −1 and −0.03 or even higher negative numbers if desired. However, the −1 to −0.3 range was learned via training a knowledge representation 200 with historic production data. See FIG. 8. The time to reach the minimum production (or time-to-minimum 328) for a given down pulse 320 can be modeled as a discrete distribution, again, learned from training the knowledge representation 200. See FIG. 9.

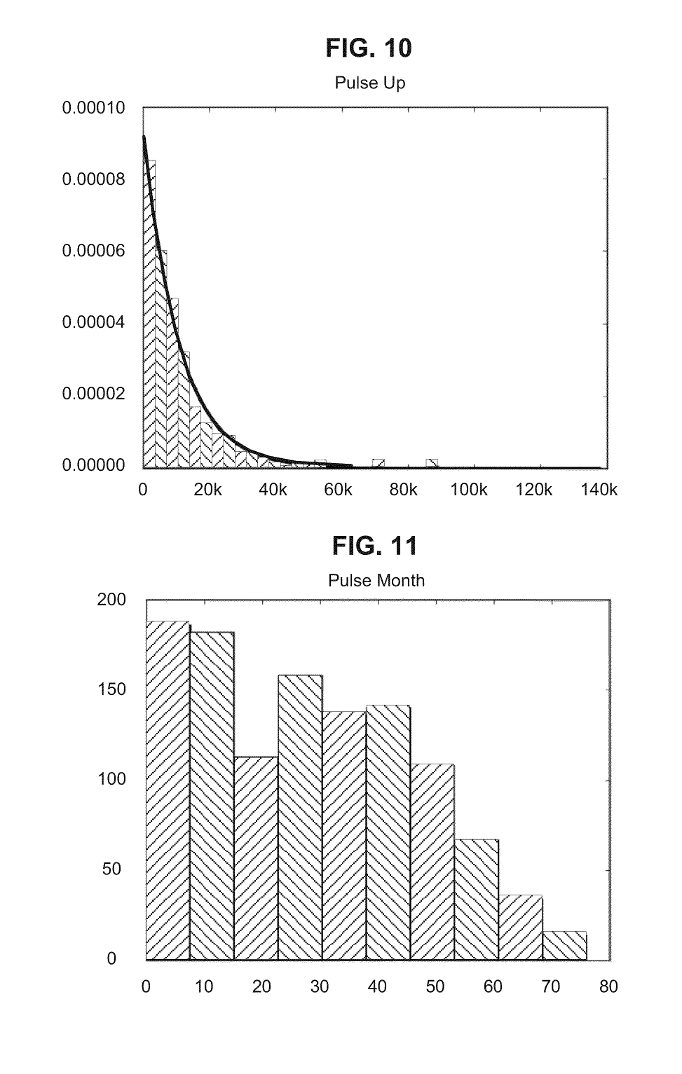

Moreover, the relative rise 326 in production during the up edge of a pulse 320 can be modeled as an exponential distribution with physically-based parameters learned from training the knowledge representation 200. See FIG. 10. The time to reach the (local) maximum (or time-to-maximum 330) is modeled as a discrete distribution in accordance with the current embodiment and which is also learned from training data. See FIG. 11.

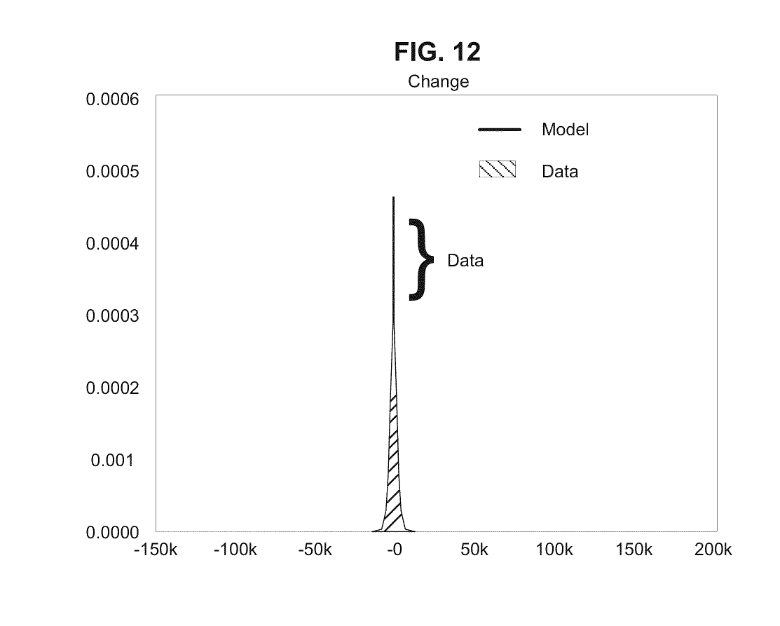

Still with reference to FIG. 3, and as disclosed elsewhere herein, production data contains a relatively large amount of noise. That noise comes from a variety of sources from mechanical/electrical failures rendering that data unavailable, unreliable, etc. to operational issues and other sources. For instance, allocated production figures might be (or become) inaccurate, well tests might fail to validate those allocated production figures accurately, etc. Moreover, this noise tends to occur in a small range near zero and thus, the knowledge representation 200 of embodiments models this noise 310 with a Laplacian distribution (see FIG. 12). The knowledge representation 200, again, is trained to determine the parameters associated with the Laplacian noise 310.

Modeling the noise 310 with a Gaussian or other distribution is possible and indeed is compliant with how the art implicitly models noise elsewhere, perhaps without even realizing it. For instance, one commonly used curve fitting technique used ubiquitously in the art (least squares curve fitting) assumes Gaussian noise rather than Laplacian noise. The Inventors realized that Laplacian noise 310 might produce better results and, at least during initial runs of the inference algorithm 124, it did. Furthermore, many geo-physical processes tend to produce Laplacian noise rather than Gaussian noise. For these reasons, and perhaps others, it is believed that Laplacian noise 310 provides satisfactory results for many production related analyses and/or forecasts.

Thus, the knowledge representation 200 of embodiments models production of a well 14 with the foregoing distributions. The knowledge representation 200, furthermore, learns the physically-based parameters associated with those distributions from training data pertaining to the historic production of the well 14. Thus, hereinafter, a trained knowledge representation 200 will be termed a “prior” 140 and it can provide some guidance as to the production which might be expected of the well 14 or that had occurred. Thus, the prior 140 itself is a useful outcome of the current embodiment. However, for forecasts, the knowledge representation 200 can be sampled by the inference algorithm 124 (see FIG. 1) to converge on a posterior distribution 134 for future production from the well 14.

More specifically, the inference algorithm 124 of embodiments executes a sequence of Markov Chain Monte Carlo (MCMC) moves to converge on a posterior distribution 132 for the physically-based parameters of the prior 140. Moreover, after each MCMC move, the inference algorithm 124 executes an iteration of the Metropolis-Hastings acceptance algorithm and accepts or rejects the sample from that move accordingly. Samples thus drawn (and accepted) will usually converge to a satisfactory posterior distribution 134 of the well's production. Of course, those samples created during the initial burn-in period (while the inference algorithm 124 is converging on the posterior distribution 132) can be discarded.

Once the posterior distribution 132 converges, it can be used to examine what the historic production “was” in a probabilistic sense. The converged posterior distribution 132 can also be used to predict, project, and/or forecast future production. These forecasts can be output in the form of histograms, P90 distributions, estimated ultimate recovery (EUR) distributions and/or other statistical distributions for the well 14. Moreover, the uncertainty associated with the production (past, present, and/or future) can also be quantified in accordance with these distributions.

In one embodiment, the MCMC moves are as follows and often lead to rapid convergence. Indeed, the inference algorithm 124 can use sparse sampling to reduce the computing resources used during the MCMC moves. Furthermore, during some MCMC moves the inference algorithm 124 draws a full sample (including one or more pulses 320) from the knowledge representation 200. The inference algorithm 124 then, in accordance with the current embodiment, alters the first decline coefficient a1 by drawing from the prior 140. The inference algorithm 124 can also alter the second coefficient a2 in a similar manner. Moreover, the inference algorithm 124 next alters the time-to-peak 312 and peak height 314 of the initial production 300 by drawing from the prior 140 (in accordance with the current embodiment).

The inference algorithm 124 can also alter a subsequent pulse by drawing from the prior 114. For instance, the inference algorithm 124 can pick a particular subsequent pulse 304 at random and alter its time-to-minimum 328, time-to-maximum 330, and/or location (trigger point t1). The inference algorithm 124 can also alter its relative drop 324 and relative rise 326. Thus, by drawing on the prior 140, the inference algorithm 124 can alter one or more subsequent pulses 304.

Furthermore, the inference algorithm 124 can create a subsequent pulse 304 by drawing its physically-based parameters from the prior 140. It can also pick an existing subsequent pulse 304 from the prior 140 and remove it. With continuing reference to FIG. 3, the inference algorithm 124 can randomly pick another subsequent pulse 304 and alter all of its physically-based parameters by sampling and/or drawing from the prior 140. Note that these “draws” are only proposals generated by the inference engine 124 and might be accepted or rejected. In some embodiments, only the draws which are accepted become samples and thereby help define the posterior.

In accordance with embodiments, the inference algorithm 124 can also make small (one percent or so) random adjustments to the first and second decline coefficients a1 and a2. Such adjustments can be made by drawing from a standard Gaussian with about one tenth (or some other fraction) of the standard deviation of the respective decline coefficient. Furthermore, during the MCMC moves, the inference algorithm 124 can also make small random adjustments to the height of the initial peak 302 and to the trigger point 322 of a randomly chosen subsequent pulse 304. Inference engines 124 of embodiments use two types of MCMC algorithms. One of these types of such algorithms are those in which new values are proposed for attributes (i.e., parameters) directly from the prior. The second types of such algorithms are those in which small changes are made to the current attribute values. The former type of moves are more consistent with the prior, and are usually readily accepted during the initial moves. However, the latter type of moves are usually consistent with the observed data (or in other words the likelihood) and these moves tend to be accepted more readily as the inference engine 124 starts converging to the optimal values.

Of course other sets of MCMC moves (and/or other types of sampling algorithms such as likelihood-weighted sampling) will work and produce convergence at various rates. For instance, the ordering of these moves could be changed and the method would still likely produce satisfactory results. But, these particular moves were chosen by an experienced statistician and have produced satisfactory results. Which ever set of MCMC moves is used, the converged posterior distribution 140 can be used to forecast the production for the well 114. Indeed, in some runs of the inference algorithm 124, it produced roughly a million high-probability scenarios or hypothesis from which possible production scenarios can be sampled to produce production statistics regardless of noisy input production data. Currently, these scenarios can be developed in under a day and projected forward to estimate EUR, NPV (net present value), associated investment risk, portfolio valuation, etc. Moreover, instead of a single, fixed, deterministic decline curve, the inference algorithm 124 outputs a production distribution and/or a risk spread thereby allowing users to evaluate not only EUR forecasts but also the risk associated with them.

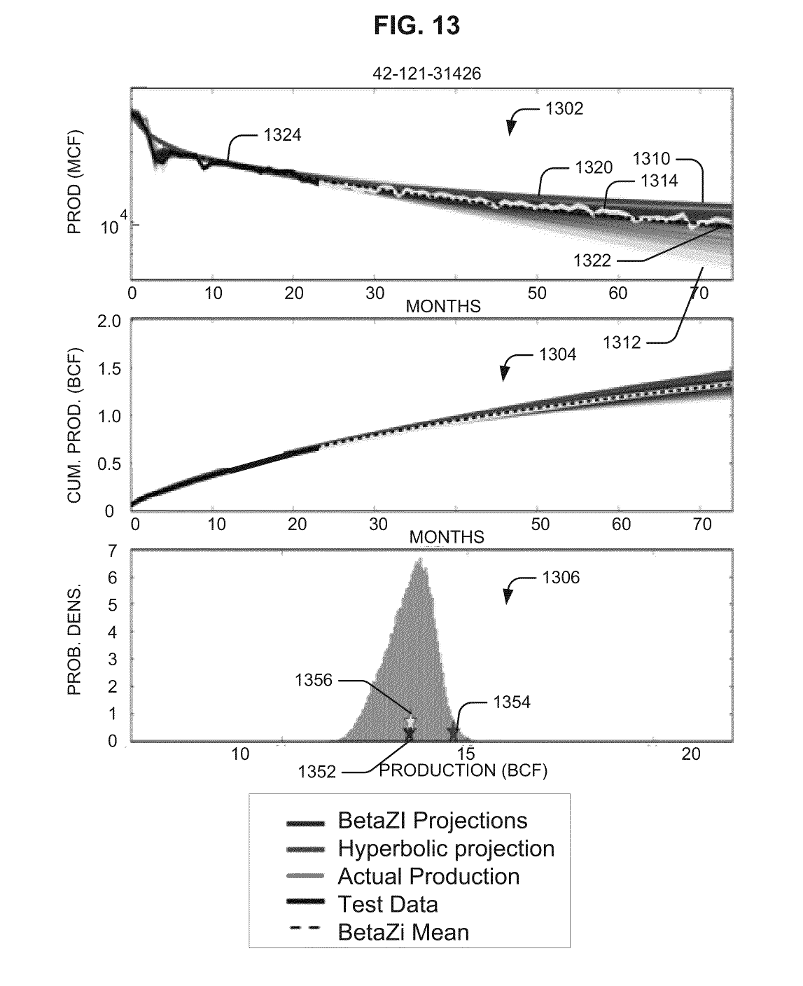

FIG. 13 illustrates a well forecast. More specifically, FIG. 13 illustrates the results from a run of the inference algorithm 124 on the prior 140. Plot 1302 illustrates a production distribution (as a probabilistic volumetric flow rate) while plot 1304 illustrates a cumulative production distribution. Meanwhile, plot 1306 illustrates the probability density for the cumulative production forecast at some select time in the future. Moreover, plots 1310 and 1312 show the upper and lower ranges of the forecast distributions generated by the inference algorithm 124, prior 140, and/or knowledge representation 200. For comparison purposes, plots 1314, 1320, and 1322 show (respectively) the mean forecast predicted by the inference algorithm 124; the forecast made by a hyperbolic model; and the estimated actual production of the well 14. Some test data measured at the wellhead (which was used to train the knowledge representation 200) is also illustrated by plot 1324.

Note that the mean forecast (plot 1314) predicted the actual production (plot 1322 as measured at the wellhead) more closely than the hyperbolic forecast (plot 1320) which was manually chosen by a petroleum engineer in a conventional fashion. Indeed, the hyperbolic forecast was off, high, by the end of the forecast period while the inference algorithm (plot 1314) was fairly near the actual production (plot 1322). Furthermore, the inference algorithm 124 forecast varied from the actual production by quite a bit less than the other forecast models over the forecast period. These results are also illustrated by the forecast cumulative production indicated by references 1352, 1354, and 1356 of (respectively) the inference algorithm 124, the hyperbolic model, and the actual cumulative production.

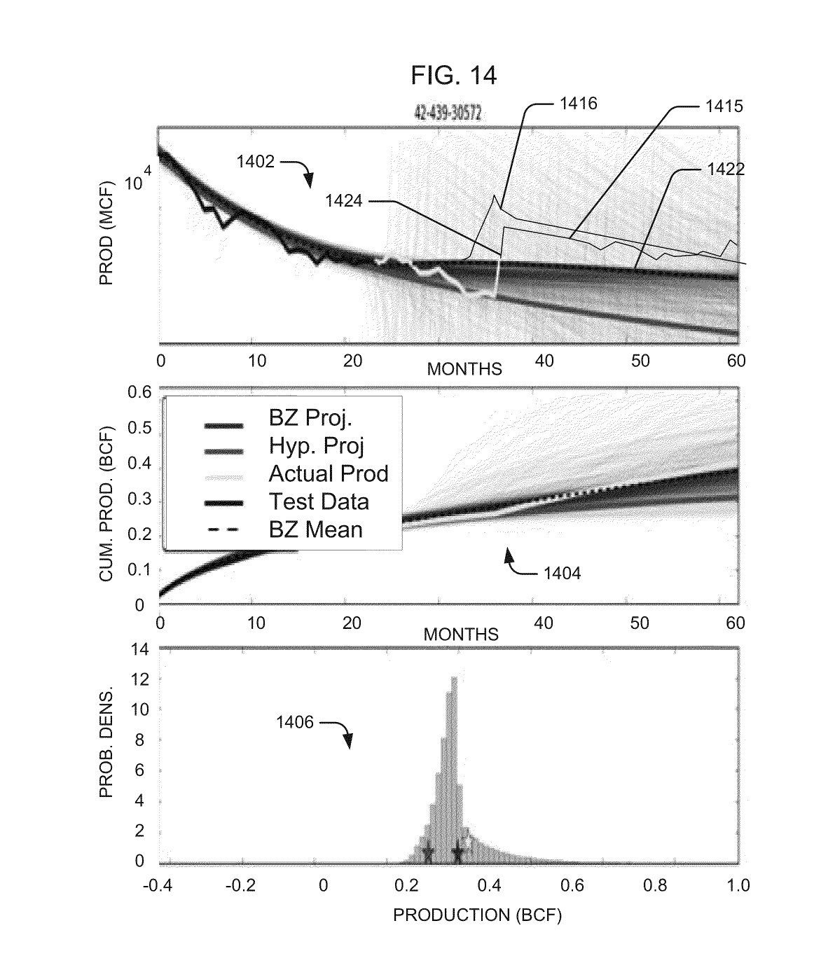

Meanwhile, FIG. 14 illustrates that the inference algorithm 124 is capable of predicting, and did predict, that a stimulation of a well 14 is likely to occur. Again, plot 1402 illustrates the rate of production (as a distribution) while plot 1404 illustrates cumulative production (as a production) with plot 1406 illustrating the probability density for the forecast cumulative production at some select time in the future. Plot 1414, meanwhile, illustrates the mean production forecast generated by the inference engine 124. Perhaps interestingly, plot 1414 does not appear to predict a stimulation. That is because plot 1414 is a mean of many differing forecasts. Most of these forecasts did predict that a stimulation would occur. However, the timing of those predicted stimulations varied (as would be expected) thereby leading to, perhaps, a slight average elevation of plot 1414.

Furthermore, plot 1415 illustrates a particular production forecast developed by the inference algorithm 124 and includes a predicted stimulation 1416. It will be appreciated that plot 1415 represents one of many forecast plots, each of which could have included (and many did include) a predicted stimulation. Similarly, the plot 1422 is the actual estimated production that occurred at this particular well 14 including an actual stimulation 1424. While the particulars of the actual stimulation 1424 and the predicted stimulation 1426 might differ, the inference algorithm 124 did predict that a stimulation would occur and did so in a large fraction of the hypothetical scenarios it sampled.

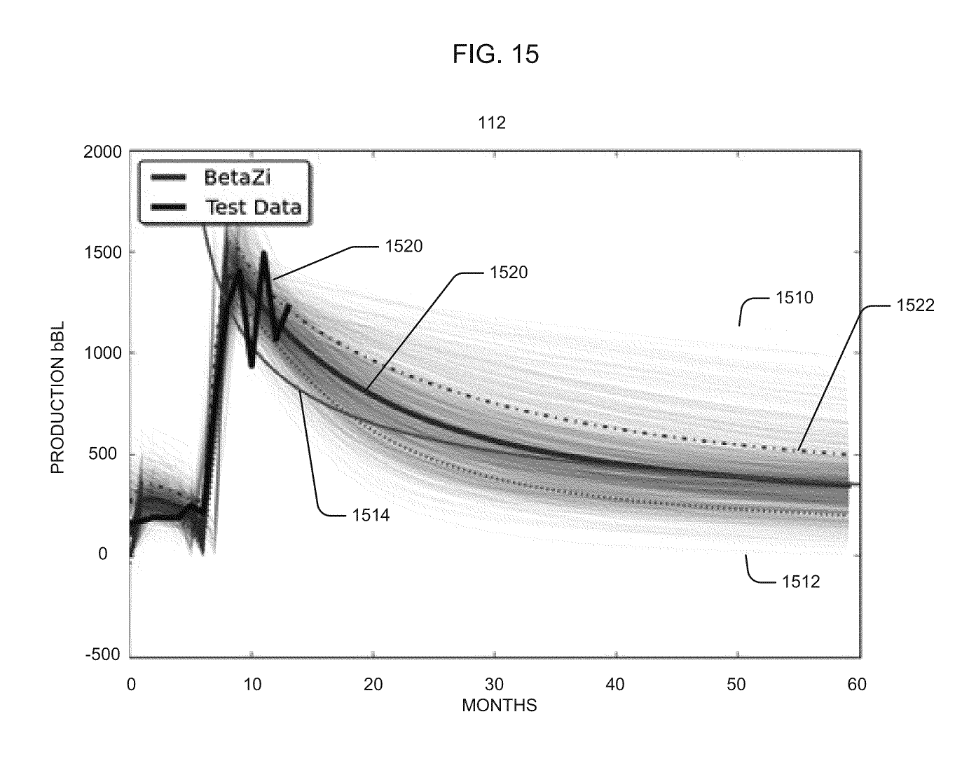

FIG. 15 illustrates a comparison between a well production forecast (distribution) and well test data. More specifically, FIG. 15 illustrates a probabilistic production forecast for the aggregate production from a multiplicity of (shale oil) wells. 14. Moreover, plots 1510 and 1512 show the upper and lower ranges of the forecast distributions generated by the inference algorithm 124, prior 140, and/or knowledge representation 200. For comparison purposes, plots 1514, 1520, and 1522 show (respectively) the forecasts made by a hyperbolic model, the actual (estimated) production of the well 14, and the mean forecast predicted by the inference algorithm 124. While the hyperbolic model (plot 1514) and the forecast made by the inference algorithm 124 (plot 1522) agree in the long term, it is the inference algorithm 124 (plot 1522) that produced the more accurate forecast (as compared to the actual production shown by plot 1520).

Thus, FIG. 15 illustrates that the inference algorithm 124 and knowledge representation 200 can combine historic production data from multiple wells and can predict their aggregate production more accurately than heretofore possible. In addition, or in the alternative, the inference algorithm 124 and knowledge representation 200 of the current embodiment can operate with data from unconventional wells 14. Furthermore, the data illustrated by FIG. 15 shows that models in accordance with the current embodiment work on conventional wells as well as unconventional shale wells.

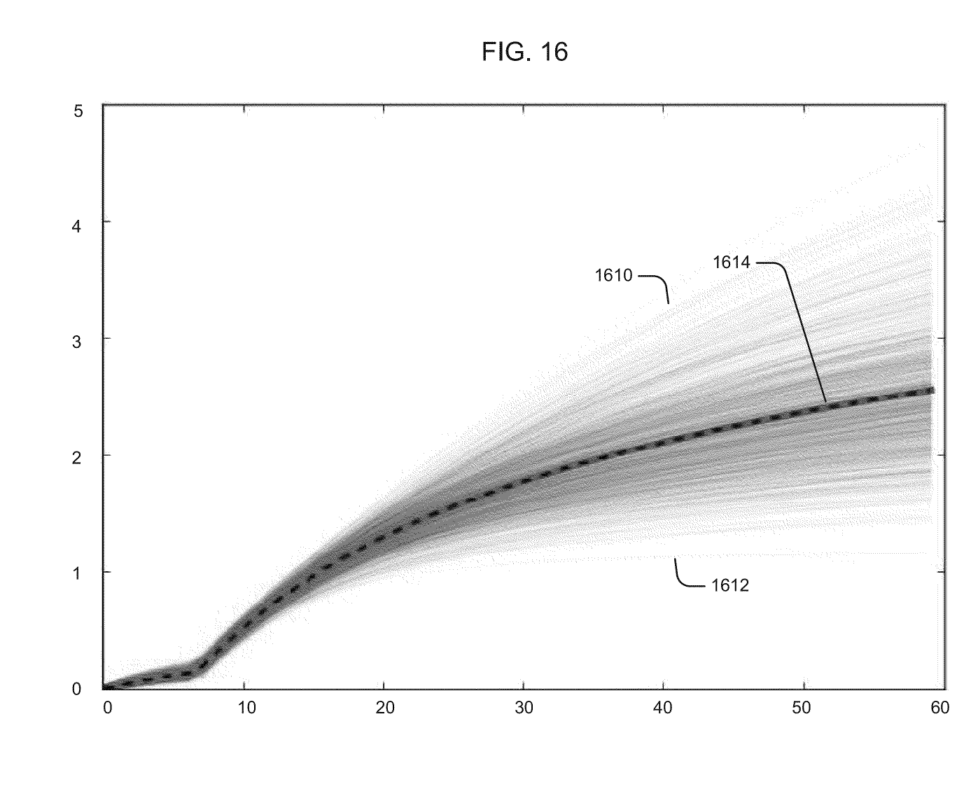

FIG. 16 illustrates a net present value prediction for a well. Indeed, NPV prediction (or, again, a distribution thereof) shown in FIG. 16 also includes an upper limit 1610, a lower limit 1612, and a median 1614 prediction for the probabilistic range of the NPV. The NPV prediction can be developed, in accordance with embodiments, by coupling the production forecast generated by the inference algorithm 124 to a model of the well's operating costs, the petrochemical market, and/or other (probabilistic) financial models. Moreover, those financial models can be probabilistic in nature.

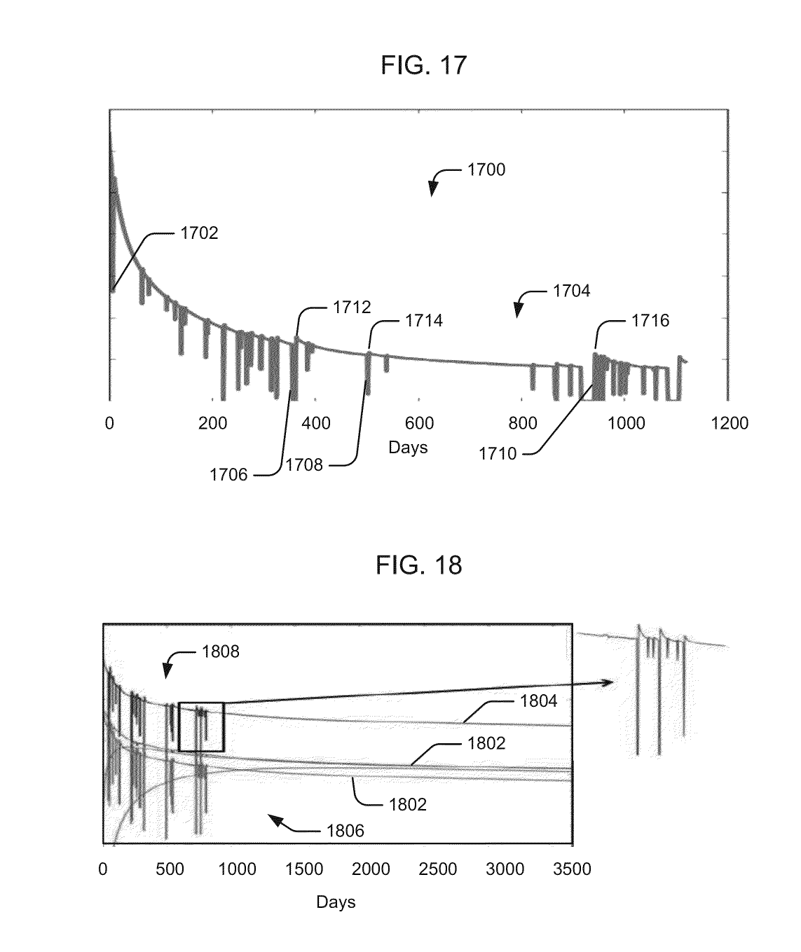

FIG. 17 illustrates predicted anomalous production after well shut-ins. More specifically, in accordance with the current embodiment, the knowledge representation 200 is configured to model gas and/or liquid flow through a well 14 believed to be composed of multiple, linked chambers 40,42, and/or 44 (see FIG. 1) and can predict anomalous flow modes therein and overall flow therefrom following shut-ins and/or other production interruptions. Thus, the production plot 1700 includes an initial ramp up 1702 and a generally declining decline curve 1704 during which shows that the well 14 will likely produce petrochemicals but at a generally slower rate as time progresses. The production plot 1700 is one of many (even millions) that could have been sampled from the prior 140 in accordance with the current embodiment.

The production plot 1700 also includes several production interruptions 1706, 1708, and 1710 during which the well 14 is predicted to be shut-in to differing degrees. As a result, in the model of the well 14, pressure builds during the shut-in 35 until the well 14 is predicted to return to service. As a result, the predicted production interruptions 1706, 1708, and 1710 are followed by predicted positive pulses 1712, 1714, and 1716 (or predicted, temporary increases in production). Those predicted positive pulses 1712, 1714, and 1716 can exceed the production that would have been expected given the general shape of the decline curve 1704.

FIG. 18 illustrates estimated flow modes within a well. In some embodiments, the knowledge representation is configured to model multi-phase flow within a well 14 with multiple, linked chambers 40, 42, 44, and 46. Thus, the knowledge representation 200 can be configured to analyze, estimate, forecast, etc. well production even in the presence of concurrent production of oil, water, natural gas, etc. More specifically, FIG. 18 illustrates four flow-mode proxy plots 1802 corresponding to the estimated flows between the linked chambers 40, 42, and or 44 (see FIG. 1). within a particular well 14. These wells are a stand in between flow regimes that are either natural, man-made, or a combination of the two. Note that the inference algorithm 124 of the current embodiment estimated/forecast these plots by drawing samples from the prior 140. FIG. 18 also illustrates a well production plot 1804 developed by the inference algorithm 124 which reflects the cumulative production at the wellhead 20 (including production from each of the flow modes (plots 1802) with appropriate time delays to account for resistance to the flow modes within, and between, the linked chambers 40, 42, and/or 44.

Note that the flow-mode proxy plots 1802 exhibit a number of shut-ins 34 and/or pulses 1806. The cumulative production plot 1804 reflects these shut-ins 34 and pulses 1806 with corresponding shut-ins 34 and pulses 1808. Eq. 2 below includes terms for each of the four flow mode plots 1802 and sums these terms to reach a term corresponding to the cumulative production plot 1804. Of course, multi-phase flow in wells 14 with multiple, linked chambers 40, 42, 44, and 46 can instead be modeled by adjusting the parameters in Eq. 1. Indeed, the MCMC moves will tend to converge on these parameters regardless of which of the many possible types of equations is selected. Nonetheless, Eq. 2 represents another model that can be incorporated into the knowledge representation 200. In this form, the two exponential decline terms have their own coefficients:

qt=q1*ê(−a1*t)+q2*ê(−a2*t). Eq. 2

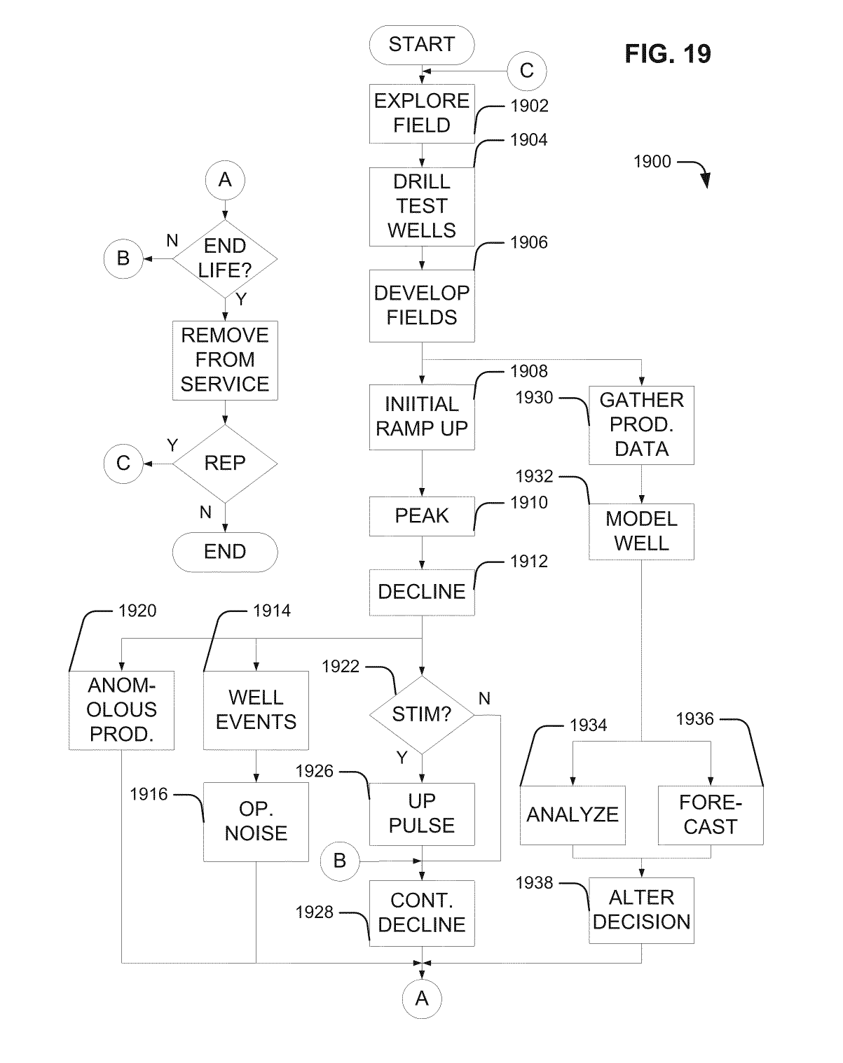

FIG. 19 illustrates a method of modeling well production. More specifically, FIG. 19 illustrates method 1900 which comprises operations such as finding and/or exploring an oilfield 10. See reference 1902. As is known, finding and exploring an oilfield 10 are operations which require a great deal of investment in real estate, equipment, personnel, etc. which stands at risk until oil is found; quantified; proven to be recoverable; wells 14 are located and drilled; and production begins. Indeed, much risk continues in production since, heretofore, it has been difficult to both accurately analyze past production and accurately forecast future production. Of the many difficulties inherent in such practices, noise in that production data which might be available tends to obscure the true production of the wells 14.

Thus, once an owner/operator discovers an oilfield 10, they often drill test wells 14 as indicated at reference 1904. The owner/operators position these wells 14 at strategically chosen locations in the oilfield 10 where, it is hoped, they will provide some initial production as well as early production data with which to value the oilfield 10. Depending on this test (production) data, the owner/operators will decide whether to develop the oilfield 10 and how to do so. For instance, they will decide how much to invest in drilling development wells 14 and where to locate those development wells 14. Again, these operations represent relatively large, risky investments. Thus, having the ability to accurately analyze and/or forecast production in an oilfield 10 represents one way to avoid these risks and to minimize or optimize the related investments. Furthermore, having the ability to quantify the risks associated with those analyzed (past) and/or future production figures represents yet another way to avoid those risks and/or optimize the related investments. Methods, systems, apparatus, etc. provided herein provide relatively accurate production analyses and forecasts as well as relatively accurate quantifications of the risks associated therewith. With reference again to FIG. 19, reference 1906 illustrates the owner/operators positioning and drilling the wells 14 selected for development.

Of course, as one or more of the wells 14 come “on line” or enter production, they will begin their initial ramp ups. See reference 1908. Furthermore, as time progresses, some of these wells 14 will reach their initial peaks as illustrated at reference 1910. Production will thereafter decline as pressure in the field decreases leading to declining flow modes (within the wells 14) and declining production at the wellheads 16, 18, 20, and 22. See reference 1912.

In the meantime, various well events might occur in one or more of the wells 14 as indicated at reference 1914. These events include, but are not limited to, shut-ins, leaks, pulses, production anomalies, etc. Moreover, ongoing operations often inject noise into the production data that might be available during the foregoing (and subsequent) operations. See reference 1916. Accordingly, anomalous production might be occurring (or appear to be occurring) at one or more of the various wells 14 as illustrated at reference 1920. Indeed, it might be the situation that production data that appears anomalous might be nominal and/or that the opposite might be the situation.

Of course, as the production decline accelerate and/or continue, the owner/operators will reach points at which they decide whether to stimulate certain wells 14 as represented by decision 1922. For those wells 14 selected for stimulations, the owner/operators might decide to partially or entirely take the wells 14 out of production to, perhaps, retrofit the wells 14 for stimulation. As a result, production can drop during preparations for stimulation thereby leading (perhaps) to economic costs associated with the decision to stimulate the wells 14. At some point, the wells 14 will be stimulated with (hopefully) increased production following as suggested by the creation of a positive production pulse. Moreover, that positive pulse might cause a beneficial effect on subsequent production. That is, the production curve for the well 14 might experience a positive offset compared to what it might have been had the stimulation not occurred.

Even so, the stimulations require an investment in equipment, personnel, etc. as well as some economic cost(s) associated with the stimulations. Of course, these stimulation decisions are based on analysis of past production data and forecasts of both the un-stimulated future production and the stimulated future production. Thus, uncertainty and/or errors in these analyses and forecasts increase the amounts of related investments as well as the risks associated therewith. Again, embodiments provide relatively accurate analyses and forecast methods, systems, apparatus, etc. as well as quantified analyses and forecast uncertainties. Following the positive production pulse (see reference 1926), though, the stimulated production will usually continue to decline albeit from an elevated/stimulated level. See reference 1928.

While various operations are occurring, production data can be gathered as illustrated at reference 1930. As disclosed elsewhere herein, it is likely that at least some of that production data will include noise to some degree. Yet, that production data (noise and all) might be the best data available to the owner/operators.

Nonetheless, owner/operators might wish to model a particular well(s) 14. See reference 1932. In accordance with embodiments, they can build a knowledge representation 200 and/or inference algorithm 124 for one or more of the wells 14. Using these components, they can analyze past production data to obtain probabilistic ranges, decline/production curves, estimates, etc. of what that past production likely was. Additionally, or in the alternative, they can forecast production to obtain probabilistic ranges, decline/production curves, estimates, etc. of what production likely will be. See references 1934 and 1936 respectively. The owner/operators can review these probabilistic analyses and/or forecasts. Based on their review, the owner/operators can alter their investment, operational, exploration, development, etc. decisions and/or activities. See reference 1938.

For instance, at some point, production at one or more wells 14 (or even oilfields 10) might have declined to a point where at it might not be possible to economically operate these wells 14. Accordingly, where the analyses and/or forecasts indicate that likely future production does not justify continued operation of the wells, the owner/operators can decide to discontinue those operations since the economic end of life of those wells 14 has probably been reached. If, though, those analyses and/or forecasts indicate that the economic end of life of some wells 14 has not been reached, the owner/operators can opt to continue operations at those wells 14. Thus, increased accuracy in these sorts of analyses and/or forecasts can render such decisions more certain and/or less risky. See references 1940 and 1942. Of course, if desired, method 1900 can be repeated in whole or in part as indicated at reference 1944.

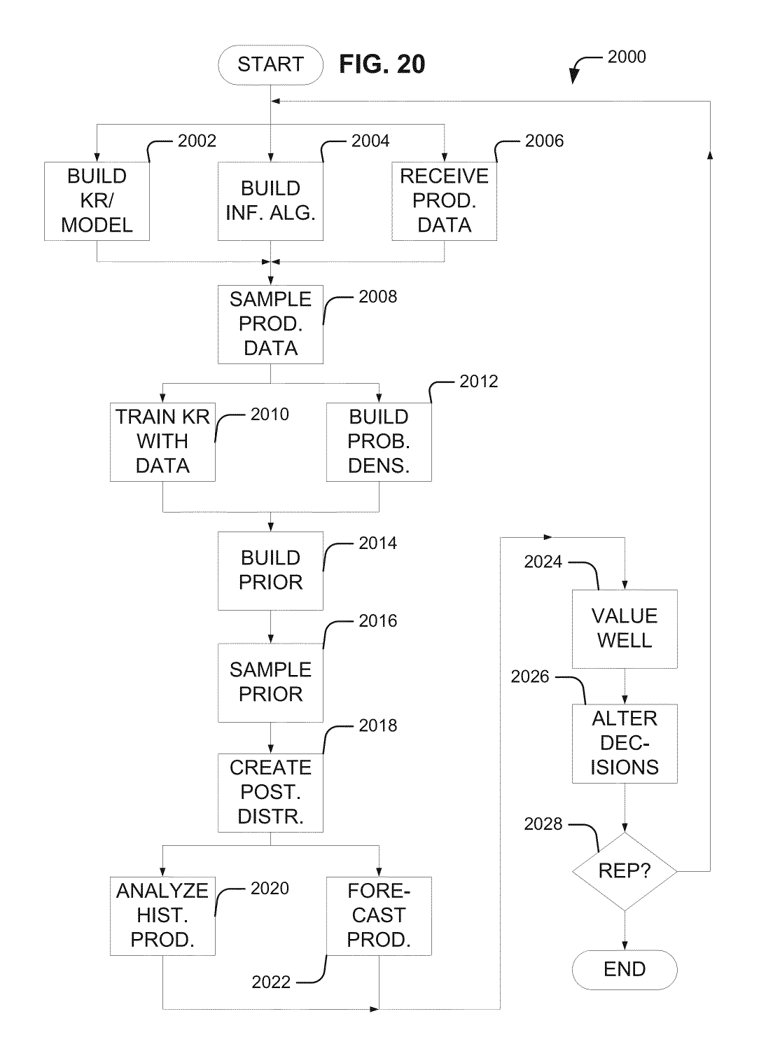

FIG. 20 illustrates another method of modeling well production. More specifically, FIG. 20 illustrates method 2000 which comprises operations such as building a knowledge representation 200 for one or more wells 14. See reference 2002. Method 2000 can also include building an inference algorithm 124 at reference 2004. Additionally, or in the alternative, method 2000 can include receiving, obtaining, gathering, etc. historic production data at reference 2006.

At reference 2008, method 2000 comprises sampling that historic production data with the knowledge representation 200. Thus, the knowledge representation can be trained with the historic production data so that probability densities for various physically-based well parameters are included in the knowledge representation 200. See references 2010 and 2012. Moreover, these operations can result in the building of a prior 140 of the knowledge representation 200 as indicated at reference 2014. Thus, a probabilistic model of the well 14 can be built rather than a fixed, deterministic model. Furthermore, a posterior distribution 132 for the production model of the well 14 with which to forecast future production can be built. For instance, the inference algorithm can sample the prior 140 of the knowledge representation 200 to create the posterior distribution 132 of the well model. See reference 2016 and 2018.

Using the model in the knowledge representation 200 and/or the posterior distributions 132 of the well model built by the inference algorithm 124, probabilistic estimates, decline/production curves, valuations, etc. of likely past production can be developed. See reference 2020. In addition, or in the alternative, probabilistic forecasts, decline/production curves, valuations, etc. of likely future production can be developed as indicated at reference 2022. Thus, the well 14 can be valued in a probabilistic manner as shown at reference 2024. Furthermore, based on those probabilistic historical estimates, forecasts, and/or valuations owner/operators can make, refine, alter, etc. investment, exploration, developments, operational, etc. decisions. See reference 2026. Moreover, decision 2028 illustrates that method 2000 can be repeated in whole or in part as desired.

Embodiments provide well analysis and forecasting methods which are unbiased, transparent, repeatable, and which execute rapidly on computers. These models can be fully automated and calibrated for use with oil, gas, water, etc. production. For instance, some methods can produce calibrated P10, P50, P90, etc. numbers. Instead of a single EUR number, various methods produce histograms and outcomes which allow users to explore the probabilistic range of EURs. The P90 numbers (or ranges) provided by some methods enjoy a high degree of confidence (90%) that they will indeed be exceeded in a given time (such as 15 years).

FIG. 21 illustrates some percentile accuracies of a method of modeling well production. Cumulative data suggests that P80 numbers produced by methods disclosed herein were exceeded 78% of the time. Moreover, a graph 2100 of the P80 percentiles (see FIG. 21) produces a straight line 2102 indicating that confidence in these P80 numbers matches reality.

Thus, individual wells can be more accurately compared, ranked, priced, etc. in accordance with embodiments. With regard to portfolio optimization, P90 statistics produced by many such methods are even more reliable since it is unlikely that each well in a portfolio will perform poorly. The abilities of embodiments to model wells and to quantify the uncertainty associated with the wells allows user to optimize their investment in the wells, their development, their operations, their stimulations, etc.

Furthermore, the current disclosure provides tools for analyzing past, and forecasting future, well production. Many of these tools are based on the physical features of the well and on probabilistic treatment of historic production data. Moreover, embodiments reduce risks associated with production forecasts (both short term and long term) by providing a range of probabilistic decline curves and by quantifying the uncertainty associated with these curves. Embodiments also, or in the alternative, safeguard trillions of dollars that would otherwise be exchanged based on outdated, manually manipulated decline curves. Owners, operators, national governments, etc. can use these production forecasts to value their reserves with reduced uncertainty.

Indeed, the physically-based probabilistic tools disclosed elsewhere herein can be used to build physically-based financial forecasting tools, physically-based securities, physically-based financial portfolios, etc. These physically-based tools allow users to manage their investments in and/or related to physical production assets (such as oil wells) while probabilistically managing many of the vicissitudes of the market. Moreover, physically-based financial tools of embodiments produce outputs such as probabilistic NPVs, probabilistic ROIs, probabilistic IRRs, and/or other physically-based financial forecast curves, histograms, summaries, etc.

Using these outputs, users can develop, structure, build, etc. various financial instruments which rest on the probabilistic and/or physical production processes described elsewhere herein. For instance, a financial underwriter could develop a collateralized petroleum obligation (CPO™ available from BetaZi, LLC.) which could possess some similarities to a collateralized debt obligation (CDO). Furthermore, these CPOs could rely on the physical production of one or more well(s) as their underlying asset(s). Because of the physically-based, probabilistic forecasting methods disclosed herein, though, the underwriters, asset managers, and/or others involved in structuring, managing, etc. the CPO™ can better understand the asset valuations and associated risks. Indeed, the underwriter could construct a portfolio with specific yield targets/risk pairings (or tranches) selected based on the outputs of various forecasting tools disclosed herein. Since heretofore available forecasting tools offer little, if anything, in the way of insight into the risks associated with production numbers (and do not account for their probabilistic nature anyway), the current embodiment affords securities that would have been too risky (for many users) to create otherwise.

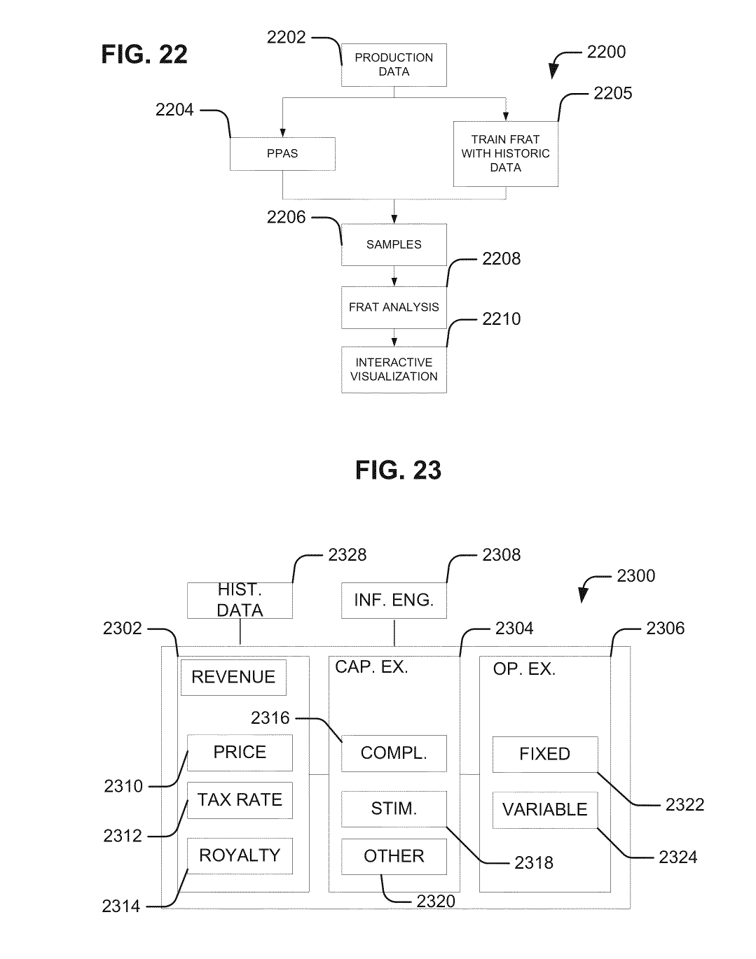

At this juncture it might be helpful to now consider a physically-based method of making financial forecasts. FIG. 22 illustrates a flowchart of such a method. Method 2200 comprises various activities such as gathering production data as indicated at reference 2202. The aforementioned production data arises from physical processes as is disclosed further else where herein. Thus, even the financial forecasts based thereon (and derivatives thereof) are controlled or at least influenced by the physics underlying the data as reflected in physical laws such as Boyle's Law (describing the interaction between the volume and pressure of gases in the wells), Darcy's Law (describing the flow of fluids through the wells), etc. Nonetheless, such data cannot ordinarily be considered as deterministic of the actual production of the associated well. Rather, that actual production might be obscured in the data by many sources of noise, inaccuracy, etc. Thus, the production data typically represents only one of a multitude of data sets that might have been produced by the well during a portion of its lifetime. Instead, the production data (for instance, production curves, decline curves, depletion curves, etc.), when viewed in accordance with embodiments, represents a probabilistic process whether modeled exponentially, hyperbolically, harmonically, etc. Nonetheless, that production data can be used as the basis for many variants of physically-based financially models of various wells.

Moreover, that production data can be fed into a physically-based, probabilistic, production analysis system (or PPAS) of embodiments as indicated at reference 2204. The PPAS can comprise a knowledge representation and inference engine. Furthermore, the PPAS can create a prior and/or posterior distribution of the production of the well by sampling the knowledge representation (see reference 2206). From these objects, the PPAS can then output a probabilistic forecast of the production of the well. Moreover, at some point, method 2200 includes training the knowledge representation 2300 (see FIG. 23) with historic data 2328 gathered from financial markets pertinent to the well(s), field(s), play(s), etc. in question. For instance, historic oil prices, market supply, market demand, interest rates, tax rates, and/or other data which bears on and/or influences the associated markets can be used to train the knowledge representation.

With continuing reference to FIG. 22, method 2200 can continue by performing a probabilistic financial analysis based on the physical production forecast provided by the PPAS. See reference 2208. In other words, method 2200 can include treating various economic/financial variables, conditions, occurrences, etc. as probabilistic entities. Thus, method 2200 can treat aspects related to revenue (for instance, prices, tax rates, royalty rates, etc.), capital expenditures (for instance, completion investments, stimulation investments, etc.), and operating expenses (for instance, fixed and/or variable costs), among others, as probabilistic concepts and handle them accordingly.

Since the production forecast is probabilistic, users (such as underwriters) can evaluate the well and determine which of a number of tranches in the CPO it could support. That is, the underwriter could designate the production of the well for a particular security or a particular tranche(s) of a security. Such capabilities allow the user to structure CDOs in manners not heretofore available in practicable, risk-aware manners. Indeed, in accordance with embodiments, method 2200 includes allowing the user to interact with the underlying physical and/or financial probabilistic models via interactive GUIs. As disclosed further elsewhere herein the users can adjust the financial aspects, inputs, variables, etc. related to the physical production so as, for instance, to further explore the tranches of the CPO(s) which they might be building. See reference 2210.

FIG. 23 illustrates a knowledge representation of a physically-based, probabilistic, financial model. The knowledge representation 2300 is an open universe, generative model of financial considerations related to physical production of oil, gas, water, etc. Moreover, the knowledge representation 2300 comprises revenue variables 2302, capital expenses 2304, and operating expenses 2306 in general. Furthermore, in accordance with the current embodiment, the revenue variables further comprise oil prices 2310, tax rates 2312, royalty rates 2314, etc. Further, the capital expenditures 2304 comprise completion expenses 2316, stimulation expenses 2318, and/or other capital expenses 2320 while the operating expenses comprise, respectively, fixed and variable costs 2322 and 2344.

The knowledge representation illustrated by FIG. 23 treats these quantities as probabilistic variables. However, the knowledge representation 2300 can allow a user to instantiate these variables with initial values which the user can select. Thus, the user can configure the knowledge representation 2300 to reflect their understanding of the economic landscape in which the wells operate and/or might operate currently and/or in the future. For instance, a user could enter a set of initial values for the variables along the lines of:

| | |
|---|---|
| oil price 2310 | $90/bbl (WTI) |
| tax rate 2312 | 11% |
| royalty rate 2314 | 5% |
| completion expense 2316 | $1M |
| stimulation expense 2318 | $1M |
| other capital expenses 2320 | $200k |
| fixed costs 2322 | $2k/year |
| variable costs 2324 | $6/bbl |

FIG. 23 also illustrates an inference engine 2308 in communication with the knowledge representation 2300. With some or all of the forgoing variables instantiated, the inference engine 2308 could begin making MCMC moves and drawing samples. Eventually, the inference engine 2308 would converge on a posterior 2326 of the financial performance of the well. Of course, samples drawn while the model was converging could be excluded from the resulting prior so as to yield a probabilistic forecast of the likely financial performance of the well based, of course, on the underlying physical production. The probabilistic financial forecast can, in accordance with embodiments, be used to structure a CPO based on the physical production of the well. Note also, that the knowledge representation 2300 can be trained with historic data 2328 as disclosed further elsewhere herein.

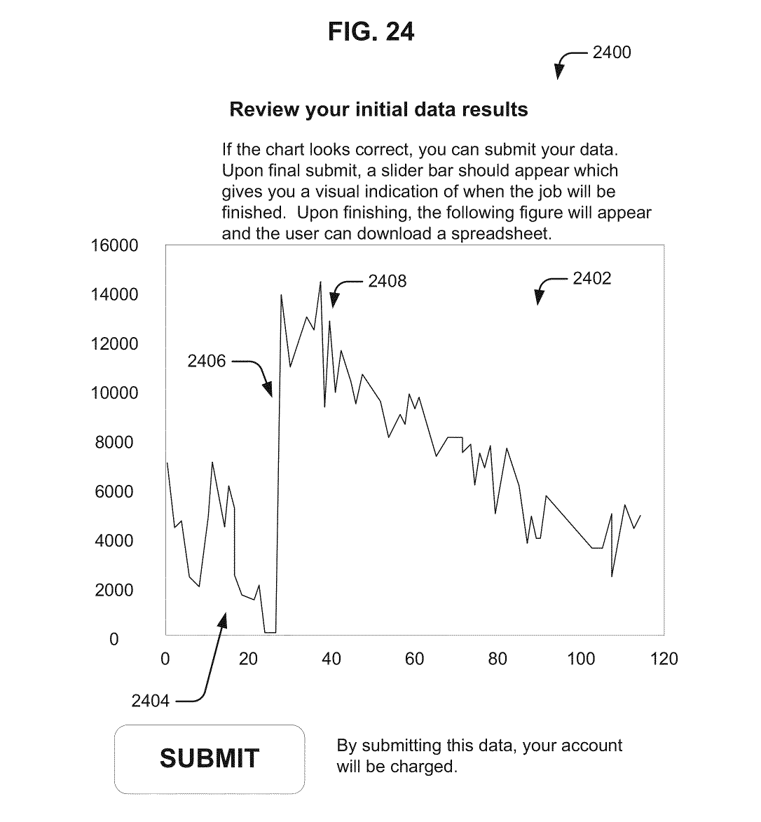

FIG. 24 illustrates a graphical user interface (or GUI) for entering physically-based production data into a system. The GUI 2400 shows that a production curve 2402 (or its underlying production data) from a well has been entered into the underlying computer. The particular production curve 2402 includes many features typically found in such data. For instance, the production curve 2402 begins with an initial phase 2404 that might be characterized by several shut-ins, subsequent up pulse, equipment failures and resulting down pulses, etc. Nonetheless, the data contained in that initial phase 2404 still reflects the physics of that particular well and can be helpful in training the knowledge representation 2300. Following the initial phase 2404, the production curve 2402 exhibits an initial ramp up 2406 followed by a trough 2408 and subsequent up pulse in production. Generally, thereafter, the production curve enters a typical decline phase 2410 which might/might not lead to a stimulation. Even so, such underlying production data can be used to train the knowledge representation 2300 of FIG. 23.

The GUI 2400 can be configured to allow users to enter the production data represented by production curve 2402 in a number of ways. For instance, a file containing the data could be dragged and dropped to the GUI 2400 from its directory, folder, window, etc. In the alternative or in addition, the file could be selected from a drop down list or found using a search facility. In some situations, the GUI 2400 could be configured to point to a streaming source of data or link to a table of production data in a database or other data repository. Moreover, wells in a portfolio or potential portfolio could be represented by icons which the user could select by clicking on one or more of them. Thus, the GUI 2400 allows users to enter production data into the system for analysis per method 2200 or other such methods.

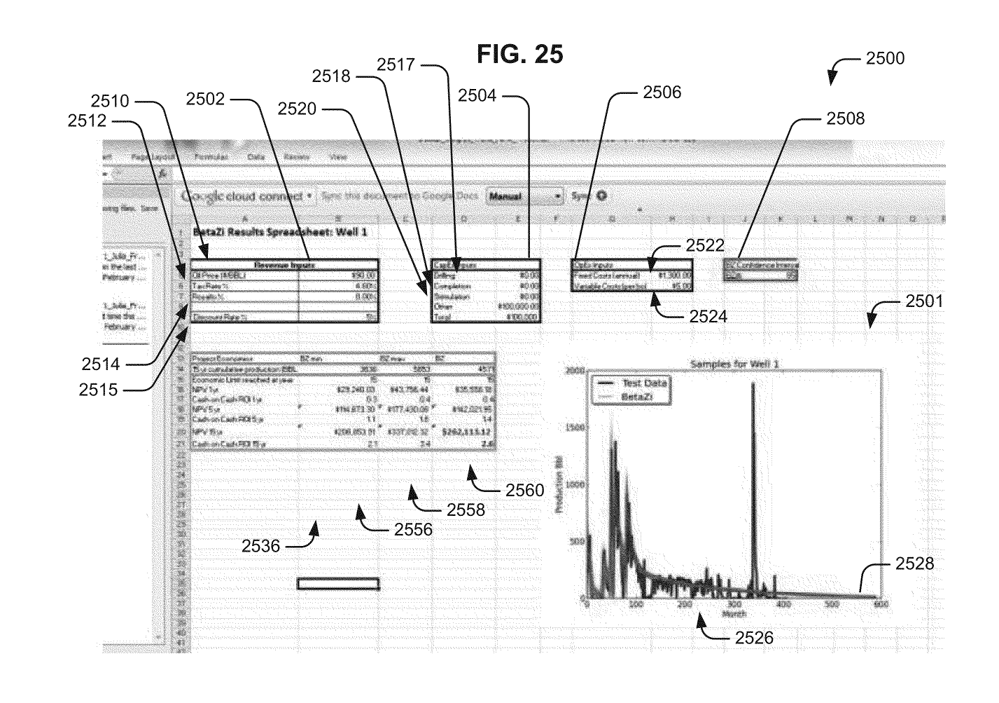

FIG. 25 illustrates a graphical user interface for conducting physically-based financial forecasts. The GUI 2500 shows a number of features including PPAS output 2501, revenue variables 2502, capital expenses 2504, operating expenses 2506, a confidence interval 2508, an oil price 2510, a tax rate 2512, a royalty rate 2514, a completion expense 2516, a stimulation expense 2518, other capital expenses 2520, fixed costs 2522, variable costs 2524, actual production data 2526, and forecast production data 2528. FIG. 25 also shows a financial forecast summary 2536, a forecast minimum 2556, a forecast maximum 2558, and a forecast mean 2560.

The PPAS output 2501 shows both the actual production data 2526 and the (mean) forecast production data 2528 generated by the PPAS. The latter curve, in accordance with embodiments, being a mean of probabilistic forecast data. These curves are provided for the convenience of potential users who might find it beneficial in understanding the physically-based financial data found elsewhere on the GUI 2500 to have available some representation of the underlying physical production.

With continuing reference to FIG. 25, the GUI 2500 is interactive in many embodiments. Thus, it includes the revenue variables 2502, capital expenses 2504, operating expenses 2506, and confidence interval 2508 in spreadsheet-like form. Accordingly, users can click on one or more of the cells in these controls and alter/input one or more of the variables therein such as an oil price 2510, a tax rate 2512, a royalty rate 2514, a discount rate 2515, a completion expense 2516, a drilling expense 2517, a stimulation expense 2518, other capital expenses 2520, fixed costs 2522, and variable costs 2524. Upon entry (or thereafter) of one ore more these variables the GUI 2500 can cause the inference engine 2308 to run a new probabilistic forecast. In accordance with embodiments, this action will cause the inference engine 2308 to (re) populate the GUI 2500 with new outputs such as (probabilistic) forecast minimums 2556, forecast maximums 2558, and forecast means 2560 for a variety of physically-based financial metrics. For instance, the inference engine 2308 can output such (probabilistic, yet, physically-based) forecasts for NPV and/or ROI at 1, 5, and 15 year (as well as other timeframe) targets. It can also generate estimates of when the well might reach its economic end of life.

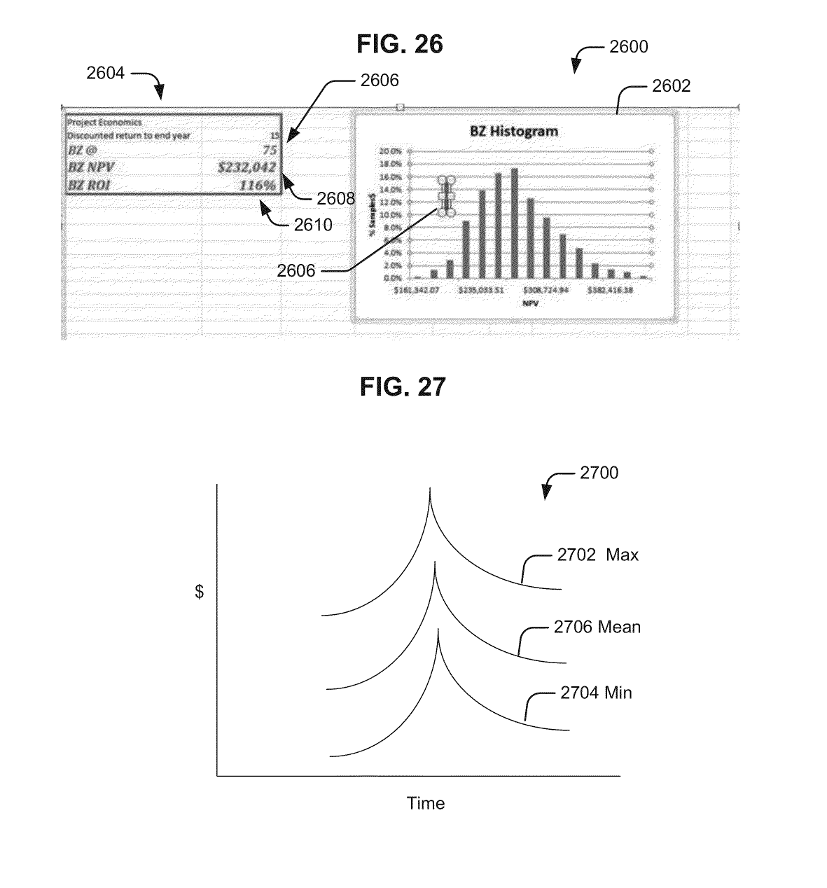

FIG. 26 illustrates another graphical user interface for outputting physically-based financial forecasts. Generally, the GUI 2600 illustrates a histogram 2602 of a financial forecast for a particular well for a particular timeframe. It also includes a summary 2604 which shows/allows a user to select a confidence interval 2606. Moreover, it shows a predicted NPV and ROI (respectively 2608 and 2610) at the projected end of life (here 15 years) for the well. FIG. 27 illustrates yet another graphical user interface for outputting physically-based financial forecasts. The GUI 2700 generally displays an upper limit 2702, a lower limit 2704, and a mean forecast for a particular well. Again, in accordance with embodiment, this forecast is both probabilistic and physically-based.

Embodiments provide physically-based financial analysis and/or forecasting methods, apparatus, and systems. Given input in the form of production records of oil, gas and/or water production from a well (possibly but not necessarily including other relevant production information such as pressure, choke, well stimulation and/or shut-in hours), oil and gas financial risk analysis tools (FRAT) disclosed herein convert the outputs of probabilistic production analysis systems into financial risk forecasts which can be used to determine the value and risk of oil and gas wells and project for a variety of financial applications.

Generally, and in accordance with embodiment, some methods proceed as follows: 1) Analyze and extract specific wells for consideration. Well production profiles can be used to assist in identifying wells as potential candidates for further treatment. For instance EURs can be predicted for a set of wells and the most promising candidates could be selected and/or 2) For physically-based, financial portfolio construction, build suitable portfolios which meet selected yield benchmarks suitable for selected audiences. Generally, royalty metrics can be derived using methods, systems, etc. disclosed herein. For some physically-based, debt securities EUR forecasts and/or the like, in accordance with methods, can provide the lender more confidence than heretofore possible in the underlying asset(s) (for instance, an oil well) and presumably afford the borrower more favorable terms (for instance, the interest rate associated with the security). Moreover, with improved confidence the borrower and/or lender can trade off higher/lower rates and the desire for collateral.

Embodiments provide physically-based financial instruments not heretofore available. For instance, embodiments provide collateral backed instruments such as CPOs, CDOs, and/or CLOs (collateralized loan obligations). Often, in financial markets, collateralized debt obligations (CDOs) are a type of asset-backed security and structured credit product. CDOs can gain exposure to the credit of a portfolio of fixed-income assets and divide the credit risk among different tranches: senior tranches such as: AAA rated tranches, mezzanine tranches (AA to BB), equity tranches, and/or unrated tranches. Losses can be applied in reverse order of seniority with junior tranches offering higher coupons (interest rates) to compensate for the higher risk. CDOs can serve as funding vehicles for portfolio investments in credit-risky fixed-income, and/or other types of assets. Other asset/collateral backed securities may also include CLOs, CPOs (Collateralized Petroleum Obligation), CBOs (corporate bond obligations), CIOs (insurance or reinsurance backed), etc. which can be based on forecasts in accordance with embodiments.

Some embodiments provide heretofore unavailable energy loan funds. These funds can be structured similar in nature to collateral backed instruments. However, with funds of the current embodiment, a loan is issued where the collateral is the underlying petroleum production, and the loan is then acquired and added into a pool of other production/collateral backed loans, to form a portfolio of production backed loans. The reserves are (at least) in part determined in accordance with methods disclosed herein

Lending-based instruments are also provided by embodiments. For instance, reserve backed PDPs (Proved Developed Producing) instruments can be developed. In these arrangements the underlying lending can be based on oil and gas reserves forecast in accordance with embodiments. The royalty valuations associated with instruments of the current embodiment can be based on the physically-based, probabilistic methods of embodiments. However, the structure of the cost analysis structure can consider factors such as WI, non-op WI, etc.).

Various embodiments also make possible royalty receivables exchange instruments. In accordance with such embodiments users can take advantage of an open marketplace in which royalty interest owners buy, sell, swap, lend against, etc. cash flows from physical assets which are backed by the production/collateral of those physical assets. Such arrangements can be listed on existing exchanges and/or new (physically-backed, receivable) exchanges which can be established for such arrangements.

Furthermore, some embodiments provide/make possible upstream master limited partnership (MLP)−ETF/ETN (exchange traded funds/exchange traded notes) like instruments. More specifically, methods provided herein can underlie instruments of the current embodiment thereby provided increased confidence, profitability, etc. of users involved. For instance, such methods can forecast production and related financial performance for these instruments whereas previously available methods could not do so (at least in a computationally practicable manner). Moreover, such methods can be accomplished with available computing resources even though they might be run against many wells (such as all wells for a major petroleum exploration/production company).

Embodiments also make possible creation of treasury bill-like instruments with fixed yields. For instance, some of these instruments could have associated therewith 2 year CPOs at 3%, 5 year CPOs at 5%, 10 year CPOs at 9%, interest paid/rate TBD. Such instruments could be structured to be fungible and therefore more tradable than might otherwise be the case. Further, exchanges can be created for such instruments. Furthermore, and in accordance with embodiments, hedging strategies, quantitative algorithmic trading models, etc. can be based on methods disclosed herein.

Some embodiments provide methods for modeling the physically-based financial performance of wells. Some of these methods comprise accepting a physically-based, probabilistic, production forecast from a model of a well via an interface. These methods also comprise modeling a financial environment associated with the well using a processor in communication with the interface and accepting a set of financial assumptions via the interface. Many such methods also comprise determining probability distributions for financial parameters associated with the well environment by training the model of the well environment with historic data pertinent to the well environment and using the processor. Additionally, models of the current embodiment comprise determining a posterior distribution for the model of the well environment by sampling the probability distributions for the parameters associated with the well environment and using the assumptions and the processor. Further, these methods comprise outputting the posterior distribution for the model of the well environment via the interface.

For some methods the model of the well environment is an open universe, generative model. Methods can also comprise determining one or more of an estimated and physical-based net present value, internal rate of return, return on investment, or an end of life for the well using the posterior distribution for the model of the well environment. If desired some methods comprise quantifying a physically-based uncertainty associated with the posterior distribution for the model of the well environment. Methods, moreover, can comprise using Markov Chain Monte Carlo sampling to converge on the posterior distributions for the model of the well environment. For methods of some embodiments the outputting of the posterior distribution of the environment further comprises outputting a plurality of physically-based curves representing the posterior distribution of the environment. Methods of some embodiments further comprise using the posterior distribution of the model of the well environment to create a physically-based collateralized petroleum obligation. Additionally, such methods can further comprise using the posterior distribution of the model of the well environment to create a physically-based tranch for the collateralized petroleum obligation. Methods of various embodiments also comprise using the posterior distribution of the model of the well environment to create a physically-based exchange traded fund and/or a physically-based fixed-yield instrument.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

What is claimed is:

1. A method comprising:
accepting a physically-based, probabilistic, production forecast from a model of a well via an interface;
modeling a financial environment associated with the well using a processor in communication with the interface;
accepting a set of financial assumptions via the interface;
determining probability distributions for financial parameters associated with the well environment by training the model of the well environment with historic data pertinent to the well environment and using the processor;
determining a posterior distribution for the model of the well environment by sampling the probability distributions for the parameters associated with the well environment and using the assumptions and the processor; and
outputting the posterior distribution for the model of the well environment via the interface.

2. The method of claim 1 wherein the model of the well environment is an open universe, generative model.

3. The method of claim 1 further comprising determining one or more of an estimated and physical-based net present value, internal rate of return, return on investment, or an end of life for the well using the posterior distribution for the model of the well environment.

4. The method of claim 1 further comprising quantifying a physically-based uncertainty associated with the posterior distribution for the model of the well environment.

5. The method of claim 1 further comprising using Markov Chain Monte Carlo sampling to converge on the posterior distributions for the model of the well environment.

6. The method claim 1 wherein the outputting of the posterior distribution of the environment further comprises outputting a plurality of physically-based curves representing the posterior distribution of the environment.

7. The method of claim 1 further comprising using the posterior distribution of the model of the well environment to create a physically-based collateralized petroleum obligation.

8. The method of claim 7 further comprising using the posterior distribution of the model of the well environment to create a physically-based tranch for the collateralized petroleum obligation.

9. The method of claim 1 further comprising using the posterior distribution of the model of the well environment to create a physically-based exchange traded fund.

10. The method of claim 1 further comprising using the posterior distribution of the model of the well environment to create a physically-based fixed-yield instrument.

11. A system comprising:
an interface;
a processor in communication with the interface; and
a memory in communication with the processor and storing processor executable instructions which when executed by the processor cause the processor to perform a process further comprising:
accepting a physically-based, probabilistic, production forecast from a model of a well via an interface,
modeling a financial environment associated with the well using a processor in communication with the interface,
accepting a set of financial assumptions via the interface,
determining probability distributions for financial parameters associated with the well environment by training the model of the well environment with historic data pertinent to the well environment and using the processor,
determining a posterior distribution for the model of the well environment by sampling the probability distributions for the parameters associated with the well environment and using the assumptions and the processor, and
outputting the posterior distribution for the model of the well environment via the interface.

12. The system of claim 11 wherein the model of the well environment is an open universe, generative model.

13. The system of claim 11 wherein the method further comprises determining one or more of an estimated and physically-based net present value, internal rate of return, estimated return on investment, or estimated end of life for the well using the posterior distribution for the model of the well environment.

14. The system of claim 11 wherein the method further comprises quantifying a physically-based uncertainty associated with the posterior distribution for the model of the well environment.

15. The system of claim 11 wherein the method further comprises using Markov Chain Monte Carlo sampling to converge on the posterior distributions for the model of the well environment.

16. The system claim 11 wherein the outputting of the posterior distribution of the environment further comprises outputting a plurality of physically-based curves representing the posterior distribution of the environment.

17. The system of claim 11 wherein the method further comprises using the posterior distribution of the model of the well environment to create a physically-based collateralized petroleum obligation.

18. The system of claim 17 wherein the method further comprises using the posterior distribution of the model of the well environment to create a physically-based tranch for the collateralized petroleum obligation.

19. The system of claim 11 f wherein the method further comprises using the posterior distribution of the model of the well environment to create a physically-based exchange traded fund.

20. A method comprising:
accepting a physically-based, probabilistic, production forecast from an open universe, generative model of a well via an interface;
modeling a financial environment associated with the well using a processor in communication with the interface;
accepting a set of financial assumptions via the interface;
determining probability distributions for financial parameters associated with the well environment by training the model of the well environment with historic data pertinent to the well environment and using the processor;
determining a posterior distribution for the model of the well environment by sampling the probability distributions for the parameters associated with the well environment and using the assumptions and the processor;
outputting the posterior distribution for the model of the well environment via the interface;
determining one or more of an estimated and physically-based net present value, internal rate of return, return on investment, or an end of life for the well using the posterior distribution for the model of the well environment;
quantifying a physically-based uncertainty associated with the posterior distribution for the model of the well environment;
using the posterior distribution of the model of the well environment to create a physically-based collateralized petroleum obligation; and
using the posterior distribution of the model of the well environment to create a physically-based tranch for the collateralized petroleum obligation.
